(19) United States
(12) Patent Application Publication
(10) Pub. No.: US 2026/0101061 A1
(43) Pub. Date: Apr. 9, 2026

(54) DECODING METHOD, ENCODING METHOD, AND NON-TRANSITORY COMPUTER-READABLE STORAGE MEDIUM

(71) Applicant: GUANGDONG OPPO MOBILE TELECOMMUNICATIONS CORP., LTD., Dongguan (CN)

(72) Inventors: Fuzheng YANG, Dongguan (CN); Junyan HUO, Dongguan (CN); Yanzhuo MA, Dongguan (CN); Ming LI, Dongguan (CN)

(21) Appl. No.: 19/417,999

(22) Filed: Dec. 12, 2025

Related U.S. Application Data
(63) Continuation of application No. PCT/CN2023/106586, filed on Jul. 10, 2023.

(51) Int. Cl. H04N 19/54; H04N 19/105; H04N 19/137; H04N 19/184; H04N 19/513

(52) U.S. Cl. CPC H04N 19/54; H04N 19/105; H04N 19/137; H04N 19/184; H04N 19/521

(57) ABSTRACT

A decoding method, an encoding method, and a non-transitory computer-readable storage medium are provided. The decoding method includes the following. Whether to split a current node in a current point cloud is determined. A motion parameter of the current node is determined by decoding a bitstream in the case where the current node is not to be split. A compensation node for the current node is determined by performing motion compensation on a reference node for the current node based on the motion parameter of the current node. A prediction node for the current node is determined based on the compensation node for the current node. Geometric position information of the current point cloud is determined based on the prediction node for the current node.

### CROSS-REFERENCE TO RELATED APPLICATION(S)

This application is a continuation of International Application No. PCT/CN2023/106586, filed Jul. 10, 2023, the entire disclosure of which is hereby incorporated by reference.

### TECHNICAL FIELD

This disclosure relates to the field of coding technology, in particular to a decoding method, an encoding method, and a non-transitory computer-readable storage medium.

### BACKGROUND

Digital video compression technology is mainly used to compress a huge amount of digital picture video data, to facilitate transmission, storage, etc.

With the surge of internet videos and higher requirements for video clarity, although a lot of video data can be saved with existing digital video compression standards, there is still a need for better digital video compression technology, to reduce the bandwidth and traffic pressure of digital video transmission.

### SUMMARY

A decoding method, an encoding method, and a non-transitory computer-readable storage medium are provided in the present disclosure.

In a first aspect, a decoding method is provided in embodiments of the present disclosure. The decoding method includes the following. Whether to split a current node in a current point cloud is determined. A motion parameter of the current node is determined by decoding a bitstream in the case where the current node is not to be split. A compensation node for the current node is determined by performing motion compensation on a reference node for the current node based on the motion parameter of the current node. A prediction node for the current node is determined based on the compensation node for the current node. Geometric position information of the current point cloud is determined based on the prediction node for the current node.

In a second aspect, an encoding method is provided in embodiments of the present disclosure. The encoding method includes the following. Whether to perform motion compensation on a current node in a current point cloud is determined. Whether to split the current node is determined in the case where motion compensation is to be performed on the current node. A first flag is encoded, where the first flag indicates whether to split the current node.

In a third aspect, a non-transitory computer-readable storage medium is provided. The non-transitory computer-readable storage medium stores thereon a computer program and a bitstream, where when processed by one or more processors, the computer program causes the one or more processors to implement the encoding method in the second aspect to generate the bitstream

Other features and aspects of the disclosed features will become apparent from the following detailed description, taken in conjunction with the accompanying drawings, which illustrate, by way of example, the features in accordance with embodiments of the disclosure. The summary is not intended to limit the scope of any embodiment described herein.

### BRIEF DESCRIPTION OF THE DRAWINGS

The disclosure is best understood from the following detailed description when read in conjunction with the accompanying drawings.

FIG. 1 is a schematic block diagram of a coding system provided in embodiments of the present disclosure.

FIG. 2 is a schematic block diagram of a geometry-based point cloud compression (G-PCC) encoding framework provided in embodiments of the present disclosure.

FIG. 3 is a schematic block diagram of a G-PCC decoding framework provided in embodiments of the present disclosure.

FIG. 4 is a schematic diagram illustrating a principle of triangle soup (trisoup)-based geometric coding provided in embodiments of the present disclosure.

FIG. 5 illustrates an example of inter information provided in embodiments of the present disclosure.

FIG. 6 illustrates an example of a process of local motion estimation provided in embodiments of the present disclosure.

FIG. 7 illustrates an example of a process of encoding a motion vector (MV) and a context of a current node provided in embodiments of the present disclosure.

FIG. 8 is a schematic flowchart of a decoding method provided in embodiments of the present disclosure.

FIG. 9 illustrates an example of a principle of motion compensation provided in embodiments of the present disclosure.

FIG. 10 illustrates an example of a principle of splitting a current node provided in embodiments of the present disclosure.

FIG. 11 is a schematic flowchart of an encoding method provided in embodiments of the present disclosure.

FIG. 12 is another schematic flowchart of an encoding method provided in embodiments of the present disclosure.

FIG. 13 is a schematic block diagram of a decoder provided in embodiments of the present disclosure.

FIG. 14 is a schematic block diagram of an encoder provided in embodiments of the present disclosure.

FIG. 15 is a schematic structural diagram of an electronic device provided in embodiments of the present disclosure.

### DETAILED DESCRIPTION

The following will illustrate technical solutions of embodiments of the present disclosure.

It may be noted that, terms used in embodiments of the present disclosure are merely intended for explaining embodiments of the present disclosure rather than limiting the present disclosure.

For example, the terms “and/or” herein only describe an association relationship between associated objects, which means that there can be three relationships. For example, A and/or B can mean A alone, both A and B exist, and B alone. The term “at least one” merely illustrates a combination relationship of listed objects, indicating that one or more items may exist. For example, at least one of: A, B, or C may indicate the following combinations: A alone, B alone, C alone, both A and B exist, both A and C exist, both B and C exist, or A, B, and C exist. Terms “a plurality of”, “the plurality of”, or “multiple” refer to two or more. The character “/” generally indicates that the associated objects are in an “or” relationship.

For another example, the term “correspondence” may mean that there is a direct or indirect correspondence between the two, may mean that there is an association between the two, may mean a relationship of indicating and indicated or configuring and configured, etc. The term “indication” may be a direct indication, may be an indirect indication, or may mean that there is an association relationship. For example, A indicates B may mean that A directly indicates B, for instance, B can be obtained according to A; may mean that A indirectly indicates B, for instance, A indicates C, and B can be obtained according to C; or may mean that there is an association relationship between A and B. Terms “pre-defined” or “pre-configured” may be implemented by pre-saving a corresponding code or table in a device (for example, including an encoder and a decoder) or in other manners that can be used for indicating related information, or may be defined in a protocol. The “protocol” may be any coding standard protocol, which is not limited in the present disclosure. The term “when” may be interpreted as “if”, “in case”, “in the case where”, “in response to”, etc. Similarly, depending on the context, the phrase “if determining” or “if detecting (a stated condition or event)” may be interpreted as “when determining”, “in response to determining”, “when detecting (a stated condition or event)”, “in response to detecting (a stated condition or event)”, etc. The terms “first,” “second,” “third,” “fourth,” “A-th,” “B-th,” etc., are used to distinguish similar objects, and are not necessarily used to describe a particular sequence or order. The terms “include”, “comprise”, and “have” as well as variations thereof are intended to cover a non-exclusive inclusion.

A point cloud is a collection of irregularly-distributed discrete points in space that represent the spatial structure and surface attributes of a three-dimensional (3D) object or a 3D scene. A surface of the point cloud is composed of densely-distributed points.

Since a two-dimensional (2D) picture has information representation at each pixel, position information thereof does not need to be recorded additionally. However, since points in the point cloud are distributed randomly and irregularly in a 3D space, a position of each point in the space needs to be recorded, such that the point cloud can be represented completely. Similar to the 2D picture, each point in the point cloud has corresponding attribute information, that is, usually a red green blue (RGB) color value. A color value reflects a color of an object. For the point cloud, in addition to colors, the attribute information corresponding to each point may be a reflectance value. The reflectance value reflects a surface material of an object. Each point in the point cloud may have geometry information and attribute information. The geometry information of each point in the point cloud refers to Cartesian 3D coordinate data of the point. The attribute information of each point in the point cloud may include, but is not limited to, at least one of color information, material information, or laser reflectance information. The color information may be information on any color space. For example, the color information may be an RGB color value. For another example, the color information may also be luminance-chrominance (YCbCr, YUV) information, where Y represents brightness (Luma), Cb (U) represents a blue chroma component, and Cr (V) represents a red chroma component. All points in the point cloud have the same amount of attribute information. For example, each point in the point cloud has two types of attribute information, i.e., the color information and the laser reflectance. For another example, each point in the point cloud has three types of attribute information, i.e., the color information, the material information, and the laser reflectance information.

A point cloud picture may be viewed from multiple directions. For example, the point cloud picture may be viewed from six directions.

A data storage format of the point cloud picture consists of header information and data. The header information contains a data format, a data representation type, the total number of points in the point cloud, and the content represented by the point cloud. For example, the header information in the data storage format of the point cloud picture may include at least one of: “.ply” format, represented by ASCII code, with a total number of 207,242 points, or each point having 3D position information (x, y, z) and 3D color information (r, g, b).

The point cloud can represent the spatial structure and surface attributes of the 3D object or scene flexibly and conveniently. In addition, since the point cloud is obtained by directly sampling a real object, which can exhibit an extremely realistic effect on the premise of ensuring accuracy, the point cloud has a wide range of application, including virtual reality (VR) games, computer-aided design, geographic information systems, autonomous navigation systems, digital cultural heritage, free point-of-view broadcasting, 3D immersive telepresence, 3D reconstruction of biological tissues and organs, etc.

Based on application scenarios, point clouds may be classified into two categories, i.e., a machine perception point cloud and a human eye perception point cloud. Application scenarios of the machine perception point cloud include, but are not limited to, autonomous navigation systems, real-time inspection systems, geographic information systems, visual sorting robots, rescue and disaster relief robots, and other point cloud application scenarios. Application scenarios of the human eye perception point cloud include, but are not limited to, digital cultural heritage, free point-of-view broadcasting, 3D immersive communication, 3D immersive interaction, and other point cloud application scenarios. Correspondingly, point clouds may be classified into a dense point cloud and a sparse point cloud based on a manner of obtaining the point clouds. Point clouds may also be classified into a static point cloud and a dynamic point cloud based on the manner of obtaining the point clouds, and more specifically, the point clouds may be classified into three types of point clouds, i.e., a first-type static point cloud, a second-type dynamic point cloud, and a third-type dynamically-obtained point cloud. For the first-type static point cloud, the object is stationary, and the device for obtaining the point cloud is also stationary. For the second-type dynamic point cloud, the object is in motion, but the device for obtaining the point cloud is stationary. For the third-type dynamically-obtained point cloud, the device for obtaining the point cloud is in motion.

A manner of capturing the point cloud includes, but is not limited to, computer generation, 3D laser scanning, 3D photogrammetry, etc. A point cloud of a virtual 3D object or scene may be generated by the computer. A point cloud of a 3D object or scene in a static real world may be obtained through 3D laser scanning, with millions of points obtained every second. A point cloud of a 3D object or scene in a dynamic real world may be obtained through 3D photogrammetry, with tens of millions of points obtained every second. Specifically, the point cloud of the surface of the object can be captured by a capturing equipment such as a photoelectric radar, a laser radar, a laser scanner, and a multi-view camera. The point cloud obtained according to a laser measurement principle may include 3D coordinate information of the point and laser reflectance of the point. The point cloud obtained according to a photogrammetry principle may include 3D coordinate information of the point and color information of the point. The point cloud obtained according to the laser measurement principle and the photogrammetry principle may include 3D coordinate information of the point, laser reflectance of the point, and color information of the point. These technologies have reduced the obtaining cost and the time period of point cloud data, and improved the accuracy of the data. For example, in medical fields, point clouds of biological tissues and organs can be obtained through magnetic resonance imaging (MRI), computed tomography (CT), and electromagnetic positioning information. These technologies have reduced the obtaining cost and the time period of point cloud data, and improved the accuracy of the data.

The transform of the method for obtaining point cloud data makes it possible to obtain a large amount of point cloud data. With an increase in application demand, the processing of massive 3D point cloud data is constrained by storage space and transmission bandwidth.

For example, a point cloud video has a frames per second (FPS) of 30, and the number of points in each frame of the point cloud is 700,000. Each point in each frame of the point cloud has coordinate information xyz (float) and color information RGB (uchar). In this case, a 10 s point cloud video has a data volume of approximately 3.15 GB (0.7 million× (4 Byte×3+1 Byte×3)×30 fps×10 s=3.15 GB). For another example, a 1280×720 2D video with a YUV sampling format of 4:2:0 and a FPS of 24 fps, the data volume of the 10 s video is approximately 0.33 GB (1280×720×12 bit×24 frames×10 s=0.33 GB), and a 10 s two-view 3D video has a data volume of approximately 0.66 GB (0.33×2=0.66 GB).

As can be seen, the data volume of the point cloud video is much greater than the data volume of the 2D video and the data volume of the 3D video with the same duration. Therefore, in order to better achieve data management, save storage space of a server, and reduce transmission traffic and transmission time between the server and a client, point cloud compression has become a key issue to promote the development of the point cloud industry.

Generally, for the point cloud compression, geometry information and attribute information of the point cloud are compressed respectively. At an encoding end, the geometry information of the point cloud is first encoded in a geometry encoder. Then, reconstructed geometry information is inputted as additional information into an attribute encoder, so as to assist attribute compression of the point cloud. At a decoding end, the geometry information of the point cloud is first decoded in a geometry decoder. Then, decoded geometry information is inputted as additional information into an attribute decoder, so as to assist attribute compression of the point cloud. The whole encoder/decoder consists of the following parts: pre-processing/post-processing, geometry encoding/decoding, and attribute encoding/decoding.

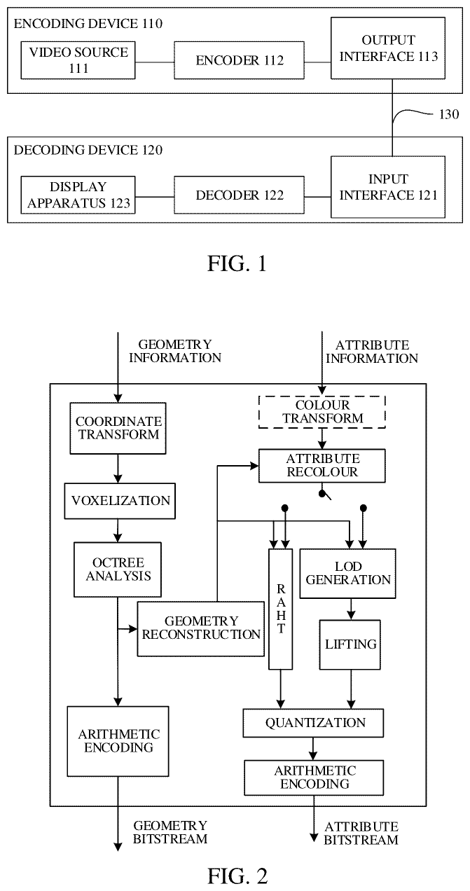

For ease of understanding, a coding system in embodiments of the present disclosure is first introduced with reference to FIG. 1.

FIG. 1 is a schematic block diagram of a coding system provided in embodiments of the present disclosure.

As illustrated in FIG. 1, the coding system 100 includes an encoding device 110 and a decoding device 120.

The encoding device 110 is configured to encode (which can be understood as “compress”) video or picture data to generate a bitstream, and transmit the bitstream to the decoding device 120. The decoding device 120 obtains decoded video or picture data by decoding the bitstream generated by the encoding device 110.

The encoding device 110 may be understood as a device having a video or picture encoding function, and the decoding device 120 may be understood as a device having a video or picture decoding function. The encoding device 110 may modulate the encoded data according to a communication standard, and transmit the modulated data to the decoding device 120. The encoding device 110 and the decoding device 120 include a wider range of devices, including smartphones, desktop computers, mobile computing apparatus, notebook (such as laptop) computers, tablet computers, set-top boxes, televisions, cameras, display devices, digital media players, video game consoles, vehicle-mounted computers, etc.

The encoding device 110 may transmit the encoded data (such as a bitstream) to the decoding device 120 via a channel 130.

The channel 130 may include one or more media and/or apparatuses capable of transferring the encoded data from the encoding device 110 to the decoding device 120. The channel 130 includes one or more communication media that enable the encoding device 110 to transmit the encoded data directly to the decoding device 120 in real-time. The communication medium includes a wireless communication medium, such as a radio frequency spectrum. The communication medium may also include a wired communication medium, such as one or more physical transmission lines. The channel 130 includes a storage medium that can store the data encoded by the encoding device 110. The storage medium includes a variety of local access data storage media, such as optical discs, digital video disks (DVDs), flash memory, etc. In this example, the decoding device 120 may obtain encoded data from the storage medium. The channel 130 may include a storage server that may store the data encoded by the encoding device 110. In this example, the decoding device 120 may download the stored encoded data from the storage server. Optionally, the storage server may store the encoded data and may transmit the encoded data to the decoding device 120. For example, the storage server may be a web server (e.g., for a website), a file transfer protocol (FTP) server, etc.

The encoding device 110 includes an encoder 112 and an output interface 113.

The output interface 113 may include a modulator/demodulator (modem) and/or a transmitter. The encoder 112 directly transmits the encoded data to the decoding device 120 via the output interface 113. The encoded data may also be stored on a storage medium or a storage server for subsequent reading by the decoding device 120.

The encoding device 110 may further include a video source 111 or a picture source in addition to the encoder 112 and the input interface 113.

The video source 111 may include at least one of a video capture apparatus (for example, a video camera), a video archive, a video input interface, or a computer graphics system, where the video input interface is configured to receive video data from a video content provider, and the computer graphics system is configured to generate video data. The encoder 112 encodes the video data from the video source 111 to generate a bitstream. The video data may include one or more pictures or a sequence of pictures. The bitstream contains encoding information of a picture or a sequence of pictures. The encoding information may include encoded picture data and associated data. The associated data may include a sequence parameter set (SPS), a picture parameter set (PPS), and other syntax structures. The SPS may contain parameters applied to one or more sequences. The PPS may contain parameters applied to one or more pictures. The syntax structure refers to a set of zero or multiple syntax elements arranged in a specified order in the bitstream.

The decoding device 120 includes an input interface 121 and a decoder 122. The input interface 121 includes a receiver and/or a modem.

The decoding device 120 may further include a display apparatus 123 in addition to the input interface 121 and the decoder 122.

The input interface 121 may receive encoded data via the channel 130. The decoder 122 is configured to obtain decoded data by decoding the encoded data, and transmits the decoded data to the display apparatus 123. The display apparatus 123 displays the decoded data. The display apparatus 123 may be integrated with the decoding device 120 or external to the decoding device 120. The display apparatus 123 may include various display devices, such as a liquid crystal display (LCD), a plasma display, an organic light-emitting diode (OLED) display, or other types of display devices.

It may be understood that, FIG. 1 is only an example of the present disclosure but not a limitation to the present disclosure. In other words, the technical solutions of embodiments of the present disclosure are not limited to the system framework illustrated in FIG. 1. For example, the technology of the present disclosure may also be applied to one-sided video encoding or one-sided video decoding.

The point cloud may be encoded and decoded respectively with various types of encoding frameworks and decoding frameworks. As an example, the coding framework may be a geometry-based point cloud compression (G-PCC) coding framework or a video-based point cloud compression (V-PCC) coding framework provided by the moving picture experts group (MPEG), and may also be an audio video standard (AVS)-PCC coding framework or a point cloud reference model (PCRM) framework provided by an AVS special interest group. The G-PCC coding framework may be used for compressing the first-type static point cloud and the third-type dynamically-obtained point cloud. The V-PCC coding framework may be used for compressing the second-type dynamic point cloud. The G-PCC coding framework is also referred to as “TMC13”, and the V-PCC coding framework is also referred to as “TMC2”. Both the G-PCC and the AVS-PCC are aimed at the static and sparse point cloud, and encoding frameworks thereof are substantially the same.

The G-PCC framework is taken below as an example for illustrating a coding framework to which embodiments of the present disclosure are applicable.

FIG. 2 is a schematic block diagram of a G-PCC encoding framework provided in embodiments of the present disclosure.

As illustrated in FIG. 2, in the G-PCC encoding framework, an input point cloud is first split into slices, and then the slices obtained through splitting are encoded independently. In a slice, geometry information of the point cloud and attribute information corresponding to points in the point cloud are encoded, respectively. In the G-PCC encoding framework, after the geometry information is encoded, the geometry information is reconstructed, and the reconstructed geometry information is used to encode the attribute information of the point cloud.

For the geometry information, in the G-PCC encoding framework, coordinate transform is first performed on the geometry information, such that the whole point cloud is contained in a bounding box. This is followed by quantization, which is mainly a scaling process. Due to rounding in the quantization, some of the points have the same geometry information. Whether to remove duplicate points is determined according to parameters. The process of quantization and duplicate point removal is also referred to as “voxelization”. Next, octree-based partitioning is performed on the bounding box, information to be encoded is determined for nodes obtained through partitioning, and then a geometry bitstream is obtained by performing arithmetic encoding on the information to be encoded.

Attribute encoding of the point cloud is focused on encoding of the colour information of the points in the point cloud. First, in the G-PCC encoding framework, colour transform may be performed on the point colour information. For example, when the colour information of the points in the input point cloud is represented using the RGB colour space, in the G-PCC encoding framework, the colour information may be transformed from the RGB colour space to the YUV colour space. The reconstructed geometry information is then used to recolour the point cloud, such that the unencoded attribute information can correspond to the reconstructed geometry information. There are two main transform methods for encoding of the colour information. One is distance-based lifting transform that relies on level of detail (LOD) partitioning, and the other is direct region adaptive hierarchal transform (RAHT), both of which transform the colour information from the spatial domain to the frequency domain to obtain high-frequency coefficients and low-frequency coefficients, and finally quantize and arithmetically encode the obtained coefficients to generate a binary bitstream.

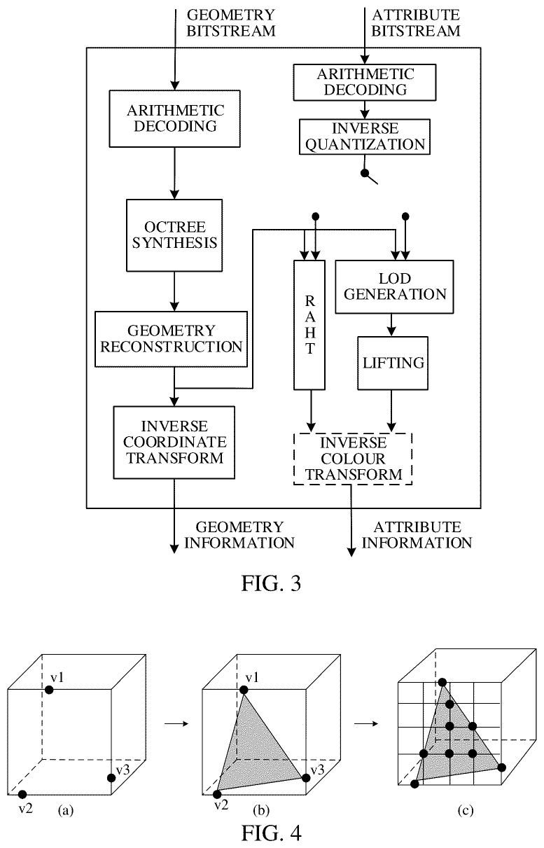

FIG. 3 is a schematic block diagram of a G-PCC decoding framework provided in embodiments of the present disclosure.

As illustrated in FIG. 3, in the G-PCC decoding framework, a bitstream of a point cloud can be obtained from the G-PCC encoding framework, and position information and attribute information of points in the point cloud can be obtained by parsing the bitstream. The decoding of the point cloud includes position decoding and attribute decoding. The process of position decoding includes the following. Arithmetic decoding is performed on a geometry bitstream. An octree is reconstructed based on decoded data, and the position information of the points is reconstructed to obtain reconstructed information of the position information of the points. Coordinate transform is performed on the reconstructed information of the position information of the points to obtain the position information of the points. The position information of the points may also be referred to as geometry information of the points. The process of attribute decoding includes the following. An attribute bitstream is parsed to obtain residual values of the attribute information of the points in the point cloud. Inverse quantization is performed on the residual values of the attribute information of the points to obtain the inverse-quantized residual values of the attribute information of the points. Based on the reconstructed information of the position information of the points obtained during position decoding, a prediction mode is selected for point cloud prediction, so as to obtain reconstructed attribute values of the points. Inverse color-space transform is performed on the reconstructed attribute values of the points to obtain a decoded point cloud.

Certainly, FIG. 1 to FIG. 4 only illustrate examples in the present disclosure, which shall not be construed as a limitation to the present disclosure. In other alternative embodiments, the decoding method and the encoding method provided in embodiments of the present disclosure are also applicable to any other type of coding systems, encoding frameworks, or decoding frameworks that meet application conditions of the decoding method and the encoding method. For example, with the development of technologies, some modules in the system or the framework mentioned above or some operations in the foregoing process may be optimized. In this case, the decoding method and the encoding method provided in embodiments of the present disclosure are also applicable to systems, frameworks, and processes optimized thereon.

In order to facilitate understanding of the solutions provided in the present disclosure, related technologies are explained below.

G-PCC geometric coding may be classified into: octree-based geometric coding, triangle soup (trisoup)-based geometric coding, and prediction tree-based geometric coding.

### (1) G-PCC Geometric Coding

The G-PCC geometric coding may be classified into: octree-based geometric coding, trisoup-based geometric coding, and prediction tree-based geometric coding.

Various geometric coding is exemplified below.

### 1. Octree-Based Geometric Coding

Encoding: first, coordinate transform is performed on geometry information to ensure all points of a point cloud are contained within a bounding box determined by two extreme points (0, 0, 0) and (2d, 2d, 2d). Then, voxelization is performed, which includes quantization, rounding, and duplicate point removal (determined according to parameters). Next, octree partitioning is successively performed on non-empty sub-cubes (containing a point(s) of the point cloud) in the bounding box in a breadth-first traversal order. At the same octree layer, a node is partitioned into 8 sub-nodes, and the partitioning stops when the obtained leaf nodes are 1×1×1 unit cubes. The 8-bit binary code generated based on whether a sub-cube is populated by a point (1 for populated, 0 for non-populated) is called an occupancy code. An occupancy code of each node is encoded to generate a binary bitstream.

Decoding: in the breadth-first traversal order, the occupancy code of each node is parsed out successively, and nodes are recursively split until the split nodes are 1×1×1 unit cubes. The number of points contained in each leaf node is parsed out, and finally, geometry reconstructed point cloud information is obtained.

### 2. Trisoup-Based Geometry Coding

Encoding: first, octree partitioning is performed. Different from octree geometry information encoding, this method does not require gradual partitioning of the point cloud into bottom-level leaf nodes with side lengths of 1×1×1. Instead, the trisoup-based geometry encoding partitions the point cloud into leaf nodes with a specified side length. Then, surface information formed by voxels in the leaf nodes is represented by a series of triangle meshes. In G-PCC, a parameter “trisoup node size” is used to represent a size of a block containing triangles. When the trisoup node size exceeds 0, a triangular patch is used to represent a voxel set in a node. Up to twelve intersection points generated by the triangular patch and twelve edges of the block are called vertices. Vertex coordinates of each block are encoded in sequence to generate a binary bitstream.

Decoding: to recover geometry coordinates of the point cloud from the triangular patch of the node, whether each voxel in the node cube intersects with the triangle patch needs to be tested. The technology is called triangle rasterization. Six unit vectors (0, 0, 1), (0, 0, 1), (0, 0, 1), (0, 0, 1), (0, 0, 1), (0, 0, 1) are used for intersection test to check whether each unit vector intersects with the triangular patch. If an intersection exists, an intersection point is calculated, and a decoded cube is output. The number of points generated in the decoder is determined by a mesh distance d.

FIG. 4 is a schematic diagram illustrating a principle of trisoup-based geometric coding provided in embodiments of the present disclosure.

As illustrated in FIG. 4, there are three vertices (v1, v2, v3) in the block illustrated in (a) of FIG. 4. As illustrated in (b) of FIG. 4, a triangular patch formed by the three vertices in a certain order is called triangle soup, i.e., trisoup. As illustrated in (c) of FIG. 4, sampling is performed on the trisoup, and the obtained sampling points are taken as a reconstructed point cloud within the block.

### 3. Prediction Tree-Based Geometry Coding

Encoding: first, the input point cloud is sorted. The sorting manners currently employed include unordered, a Morton order, an azimuth order, and a radial distance order. At an encoding end, a prediction tree structure is established in two different manners: a KD-Tree (high-latency slow mode) and a low-latency fast mode that uses LiDAR calibration information to split each point into different lasers and establishes a prediction structure based on different lasers. Next, based on the structure of the prediction tree, each node in the prediction tree is traversed. Different prediction modes are selected to perform prediction on geometry position information of the node to obtain a prediction residual, and a quantization parameter is used for quantizing the geometry prediction residual. Finally, through successive iterations, the prediction residuals of the position information of the nodes in the prediction tree, the prediction tree structure, and the quantization parameter are encoded to generate a binary bitstream.

Decoding: a decoding end successively parses a bitstream to reconstruct the prediction tree structure. Then, geometry position prediction residual information and the quantization parameter of each prediction node are obtained through parsing, and inverse quantization is performed on the prediction residual to obtain reconstructed geometry position information of each node. Finally, geometry reconstruction at the decoding end is completed.

### (2) G-PCC Dense Point Cloud Inter Prediction Technology

### 1. Inter Information

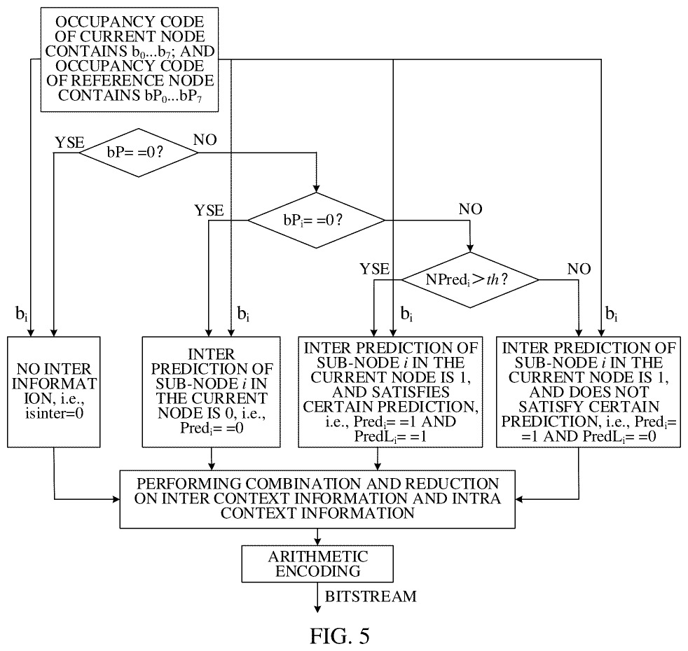

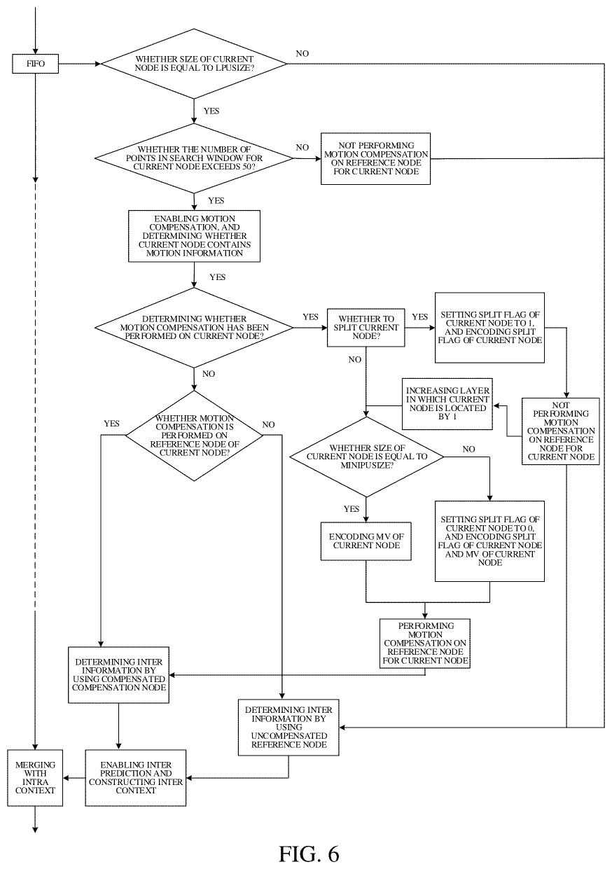

FIG. 5 illustrates an example of inter information provided in embodiments of the present disclosure.

As illustrated in FIG. 5, an occupancy code of a current node contains b₀ . . . b₇, and an occupancy code of a reference node contains bP₀ . . . bP₇. An encoder can obtain inter information of the current node according to populated status of the reference node, take the inter information as information in a context of the current node, and obtain a prediction node for the current node by performing prediction on the occupancy code of the current node. In addition, after obtaining the inter information, the encoder may also perform combination and reduction on the inter information according to intra information of the current node, and obtain a bitstream by performing arithmetic coding on reduced information. The reference node refers to a node on which motion compensation is not performed, for example, the reference node may be a node in a reference picture with the same position as the current node. In other words, the occupancy code of the reference node may be directly obtained from a point cloud of a reference frame.

Certainly, in another embodiment, the encoder may obtain inter information of the current node according to populated status of a compensation node, take the inter information as information in a context of the current node, and obtain a prediction node for the current node by performing prediction on the occupancy code of the current node. The compensation node is a node obtained by performing compensation on a reference node based on a motion parameter. In other words, an occupancy code of the compensation node may be obtained from a compensation point cloud. Specifically, the encoder can determine, depending on whether motion compensation needs to be performed on the current node, to obtain the inter information of the current node according to the populated status of the reference node or the populated status of the compensation node.

Taking the inter information obtained according to the reference node as an example, the inter information may be classified into the following categories.

(a) the inter information is not used (No pred): when the occupancy code of the reference node (i.e., bP₀ . . . bP₇) is 0, none of sub-nodes in the reference node are populated (e.g., bP==0). In other words, when the occupancy code of the reference node (bP₀ . . . bP₇) is 0, the inter information is not used for the current node (i.e., isinter=0).

(b) when sub-node i in the reference node is empty (e.g., bPᵢ==0), sub-node i in the current node is predicted to be non-populated (i.e., Predᵢ==0).

(c) when sub-node i in the reference node is non-empty (e.g., bPᵢ==1), sub-node i in the current node is predicted to be populated (i.e., Predᵢ==1). In this case, two cases may be further obtained according to the number of points contained in sub-node i in the reference node. Case 1: when the number of points in sub-node i in the reference node (e.g., denoted as NPredᵢ) exceeds threshold th, sub-node i in the current node is certainly predicted to be populated (e.g., PredLᵢ==1). Case 2: when the number of points in sub-node i in the reference node (e.g., denoted as NPredᵢ) does not exceed threshold th, sub-node i in the current node is not certainly predicted to be populated (e.g., PredLᵢ==0).

The threshold is set to 2 in TMC13 v22 and GES.

### 2. Local Motion Estimation

In G-PCC, local motion estimation is performed on a non-radar dense point cloud. Whether local motion estimation is enabled for a certain layer is determined according to a local motion enabled flag (localMotionEnabled) in a geometric parameter set (GPS) layer. Local motion estimation is used for block (prediction unit, PU)-based inter prediction. The encoder reads a largest prediction unit (LPU) size (LPUsize) and the number of layers used for block prediction from configuration parameters, and calculates a minimum prediction unit (miniPU) size (miniPUsize). Then, the encoder implements local motion estimation based on the LPUsize and the miniPUsize.

FIG. 6 illustrates an example of a process of local motion estimation provided in embodiments of the present disclosure.

As illustrated in FIG. 6, the process of local motion estimation may include the following.

(a) when a size of a current node in a current layer exceeds the LPUsize, no motion vector (MV) can be used to perform motion compensation on a reference node for the current node, and thus populated information (i.e., occupancy information on which motion compensation is not performed) of the reference node is directly used as information in a context of the current node.

(b) when the size of the current node in the current layer is equal to the LPUsize, first, whether local motion is enabled is decided by determining whether the number of points in the reference node for the current node exceeds 50. For example, local motion is enabled when the number of points in the reference node for the current node exceeds 50.

Specifically, after the encoder enables motion compensation on the current node, the encoder first encodes a recursive prediction unit (PU) structure (PU_tree). Each node in the recursive PU structure may be further split, and an MV of each sub-node can be used to perform motion compensation on the reference node. Alternatively, an MV of the current node unsplit can be directly used to perform motion compensation on the reference node. The recursive PU structure records the following information of each node: a flag (split_flag) indicating whether to split, a flag (isCompensated) indicating whether compensation is performed, and a set of MVs. Then, the encoder determines whether the current node contains motion information (hasMotion). If the current node contains motion information, whether motion compensation has not been performed on the current node (i.e., whether!isCompensated is true) is determined. Based on a result of determining whether motion compensation has not been performed on the current node (i.e., whether!isCompensated is true), the encoder may perform or may not perform motion compensation on the reference node for the current node.

If motion compensation has not been performed on the current node (i.e., !isCompensated is true), whether to split the current node is determined (i.e., determining whether currNode[depth].split_flag==1 is true). If it is determined to split the current node (i.e., currNode[depth].split_flag==1 is true), a split flag of the current node is set to 1 (i.e., split_flag==1), and the split flag of the current node is encoded; and it is determined not to perform motion compensation on the reference node for the current node (i.e., currNode[depth].isCompensated==0), i.e., inter information determined by using a uncompensated reference node is taken as the information in the context of the current node. If it is determined not to split the current node, the encoder further determines whether the size of the current node is equal to the miniPUsize (i.e., determining whether currNode[depth].size==miniPU.size is true). If the size of the current node is equal to the miniPUsize (i.e., currNode[depth].size==miniPU.size is true), the MV of the current node is encoded; and if the size of the current node is not equal to the miniPUsize (i.e., currNode[depth].size==miniPU.size is false), the split flag of the current node is set to 0 (i.e., split_flag==0), and the split flag of the current node and the MV of the current node are encoded. It is worth noting that, regardless of whether the size of the current node is equal to the miniPUsize, it is determined to perform motion compensation on the reference node for the current node (i.e., currNode[depth].isCompensated==1), i.e., inter information is determined by using a compensation node obtained by performing motion compensation on the reference node for the current node, and the inter information is used as the information in the context of the current node.

If motion compensation has been performed on the current node, it is determined whether motion compensation needs to be performed on the reference node for the current node. If motion compensation is performed on the reference node for the current node (i.e., currNode[depth].isCompensated==1 is true), the inter information is determined by using the compensation node obtained by performing motion compensation on the reference node for the current node, and the inter information is used as the information in the context of the current node; and if motion compensation is not performed on the reference node for the current node (i.e., currNode[depth].isCompensated==1 is false), the inter information determined by using the uncompensated reference node is used as the information in the context of the current node.

In addition, after the encoder obtains the inter information of the current node, the encoder enables inter prediction and constructs an inter context, and then merges the inter context with an intra context.

As can be seen, the current node may contain the following parameters:
(a) popul_flags: populated status of a PU;
(b) split_flags: a split flag;
(c) MVs: motion vectors;
(d) isCompensated: If isCompensated is 1, it indicates that motion compensation has been performed on the reference node for the current node; and if isCompensated is 0, it indicates that motion compensation has not been performed on the reference node; and
(e) hasMotion: indicating whether the current node contains motion information. If the current node contains motion information, hasMotion is 1; otherwise, hasMotion is 0.

### (3) an MV and a Motion-Compensation Layer are Determined Based on Rate-Distortion Optimization (RDO)

### 1. Optimal MV Selection and Encoding

### (a) MV Search (i.e., how to Obtain an MV)

### Manner 1: Motion Estimation Criterion

A matching metric is obtained by applying log( ) to a sum of a respective absolute difference between each point in the reference node and the current node (Manhattan distance).

### Manner 2: Search Algorithm

In a search window for the current node, a position of the reference node is taken as a starting point, a search is performed along 18 surrounding directions to find two optimal MVs, and a search distance is gradually reduced through iteratively reducing the search step size, and finally, an optimal MV is obtained.

$$D ( B , P ) = {\sum }_{b ∈ B} {log}_{2} ( 1 + {min}_{p ∈ P} {‖ b - p ‖}_{1} )$$

where B represents a current node, P represents a reference node, b represents points in the current node, and p represents points in a prediction mode.

### (b) Calculating Bitrate for Encoding Each MV

A context, i.e., mvIsZero, mvIsOne, mvSign, and _ctxLocalMV, is set according to a value of the MV of the current node, and entropy for encoding the MV is calculated, where mvIsZero indicates whether the value of the MV is 0, mvIsOne indicates whether the value of the MV is 1, mvSign indicates a sign of the value of the MV, and_ctxLocalMV is used to determine the value of the MV.

(c) the Optimal MV is Associated with Split_Flag

### 2. Selecting Whether to Split a PU Based on the RDO

The flag split_flag indicating whether to split the current node is determined based on a total cost Cost calculated from a distortion between the reference node and the current node, encoding the MV, and encoding the split_flag (when it is 0, the reference node is not compensated; otherwise, the reference node is compensated).

A Cost calculation process is as follows. When the encoder sets split_flag to 0 or 1, a corresponding MV is determined. For example, by using a specific set of encoding parameters (e.g., when an MV MV1 is used in case of no splitting), the bitrate and the distortion under such a condition, i.e., rate-distortion performance (R,D), can be obtained. For example, a Lagrange multiplier may be introduced to search for an encoding parameter with the minimum distortion (D) while a certain bitrate limit (R) is satisfied.

For example, a Lagrange multiplier formula for calculating the total cost is as follows:

$$C = \sum i [ D ( B , P ( W , Vi ) ) + λ R ( V i ) ] + λ R ( split flags ) + λ R ( pop flags )$$

where i represents the i-th sub-node of the current node, D represents distortion, B represents the current node, P represents a reference node, W represents a search window for the current node, Vi represents an MV of the i-th sub-node of the current node, R represents a bitrate, split flags represents a split flag of the current node, pop flags represents a flag related to populated information of the current node, and λ represents a calculation coefficient for calculating a Lagrange multiplier.

As can be seen, the encoder determines the optimal MV and the value of split_flag of the current node by comparing a cost of splitting with a cost of non-splitting.

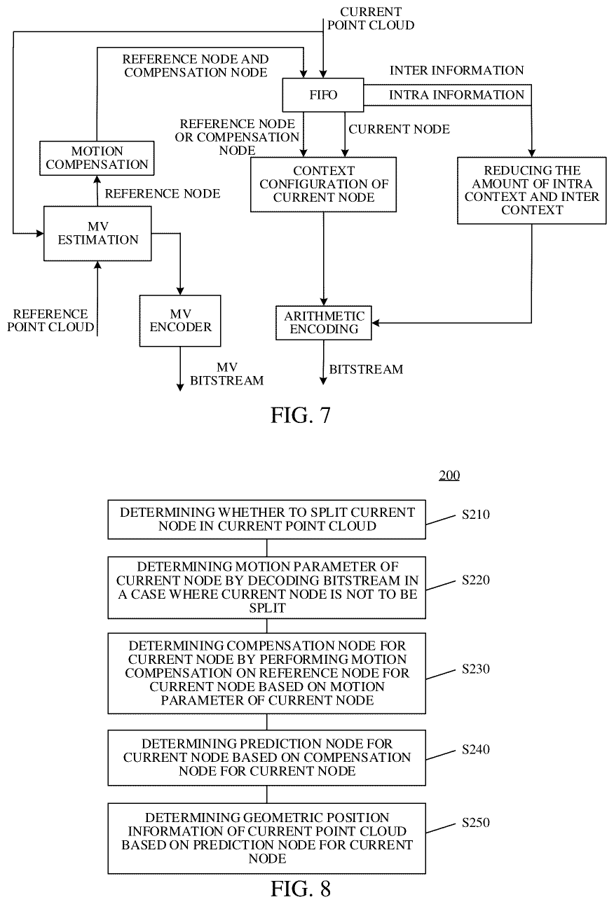

FIG. 7 illustrates an example of a process of encoding an MV and a context of a current node provided in embodiments of the present disclosure.

As illustrated in FIG. 7, the encoder obtains a reference node for a current node based on a reference point cloud and an input current point cloud, obtains an MV of the current node through MV estimation, and obtains a compensation node by performing motion compensation on the reference node. Based on this, when the encoder encodes the current node in the current point cloud, the encoder can output inter information and intra information based on the current node and the reference node (or the compensation node) output from an FIFO. Based on the inter information and the intra information, the encoder can reduce the amount of intra context and inter context, and obtain a bitstream by performing arithmetic encoding on the reduced contexts. In addition, the encoder may also perform arithmetic encoding on a context configuration output from the FIFO. Moreover, the encoder may also obtain an MV bitstream by using an MV encoder to encode the information (e.g., the MV) output from the MV estimation.

As can be seen from the above, when the encoder performs motion compensation on the reference node for the current node, the process involved is complicated and redundant. For example, both currNode[depth]. split_flag==1 and currNode[depth].isCompensated==1 can indicate performing motion compensation on the reference node for the current node, that is, there is a redundant flag, which may increase the complexity of motion compensation performed by the encoder and reduce the encoding efficiency of the encoder, and accordingly, reduces the decoding performance of the decoder.

In view of this, the present disclosure provides a decoding method that can improve the decoding performance of the decoder by simplifying an inter prediction process of the decoder.

FIG. 8 is a schematic flowchart of a decoding method 200 provided in embodiments of the present disclosure. It may be understood that, the decoding method 200 may be performed by a decoder. For example, the decoding method 200 may be performed by the decoding device 120 or the decoder 122 as illustrated in FIG. 1. For another example, the decoding method 200 may be performed by the decoding framework as illustrated in FIG. 3. For ease of illustration, the following is illustrated by taking the decoder as an example.

As illustrated in FIG. 8, the decoding method 200 may include some or all of the following.

At S210, the decoder determines whether to split a current node in a current point cloud.

Exemplarily, the decoder determines whether to split the current node into multiple sub-nodes.

For example, the current node may be a PU. A PU is a voxel block obtained by splitting a point cloud (or slice) of a current frame according to certain rules, and a PU is a basic unit for prediction. A size of a PU may be subject to certain restrictions. For example, a PU with the maximum allowed size is referred to as an LPU, and a PU with the minimum allowed PU size is referred to as a miniPU. An LPUsize may be carried in a sequence parameter set (SPS) parameter or a geometrical block head (GBH) parameter, such as sps_LPU_size and gbh_LPU_size, which can indicate the depth of the LPU in an octree partitioning structure of the current picture. A miniPUsize may be carried in an SPS parameter or a GBH parameter, such as sps_miniPU_size and gbh_miniPU_size, which can indicate the depth of the miniPU in the octree partitioning structure of the current picture or a depth difference between the miniPU and the LPU.

At S220, the decoder determines a motion parameter of the current node by decoding a bitstream in the case where the current node is not to be split.

Exemplarily, in the case where the current node is not to be split, the decoder, by default, determines the motion parameter of the current node by decoding the bitstream.

At S230, the decoder determines a compensation node for the current node by performing motion compensation on a reference node for the current node based on the motion parameter of the current node.

Exemplarily, in the case where the current node is not to be split, the decoder, by default, determines the motion parameter of the current node by decoding the bitstream, and determines the compensation node for the current node by performing motion compensation on the reference node for the current node based on the motion parameter of the current node. In other words, in the case where the current node is not to be split, the decoder, by default, performs motion compensation on the reference node for the current node. Specifically, the decoder, by default, performs motion compensation on the reference node for the current node based on the motion parameter of the current node determined by decoding the bitstream.

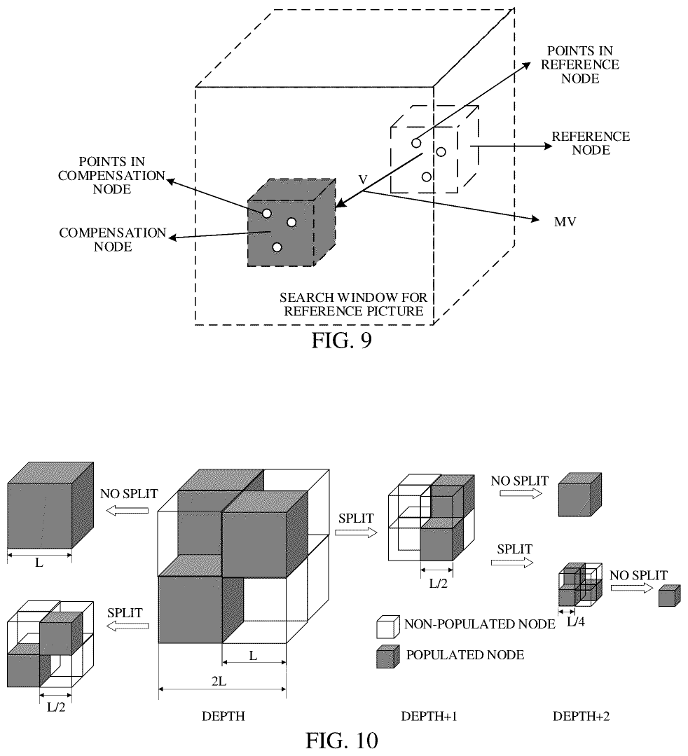

FIG. 9 illustrates an example of a principle of motion compensation provided in embodiments of the present disclosure.

As illustrated in FIG. 9, the decoder determines the reference node for the current node in a reference picture, determines the motion parameter (e.g., may be an MV) of the current node by decoding the bitstream, and obtains the compensation node by shifting (i.e., performing motion compensation on) the reference node according to the motion parameter of the current node.

At S240, the decoder determines a prediction node for the current node based on the compensation node for the current node.

Exemplarily, the decoder may directly determine the compensation node for the current node as the prediction node for the current node.

For example, the decoder may determine inter information of the current node based on the compensation node for the current node, construct a context of the current node based on the inter information, and determine the prediction node for the current node based on the context of the current node. For example, the context of the current node can be used as an input, and an entropy decoder in the decoder can be used to output the prediction node for the current node.

At S250, the decoder determines geometric position information of the current point cloud based on the prediction node for the current node.

Exemplarily, the decoder determines the geometric position information of the current point cloud based on a prediction node for a node(s) at each layer of the current point cloud, where each layer includes a current layer where the current node is located.

Exemplarily, the decoder obtains an octree structure by performing octree partitioning (certainly, other partitioning modes may be used) on the current point cloud. During prediction decoding, whether to split the current node at the current layer of the octree structure is determined. When the current node is not to be split, the decoder determines the motion parameter of the current node by decoding the bitstream, and then determines the compensation node for the current node by performing motion compensation on the reference node for the current node based on the motion parameter of the current node. Based on this, after motion compensation is performed on all nodes in the current point cloud that require motion compensation, the geometric position information of the current point cloud can be obtained.

In this embodiment, in the case where the current node is not to be split, the motion parameter of the current node can be directly determined by decoding the bitstream, that is, motion compensation is directly performed on the reference node for the current node. In other words, the case where the current node is not to be split is directly associated with performing motion compensation on the reference node for the current node, such that a flag indicating whether motion compensation is required may not be introduced in a motion compensation process of the decoder, thereby improving the decoding performance of the decoder.

In some embodiments, the S210 may include the following. A first flag is determined by decoding the bitstream, where the first flag indicates whether to split the current node.

Exemplarily, the decoder determines the first flag by decoding the bitstream. In the case where the first flag indicates splitting of the current node, it is determined to split the current node; otherwise, it is determined not to split the current node.

Exemplarily, when a value of the first flag is a first value, it indicates splitting of the current node, and when the value of the first flag is a second value, it indicates non-splitting of the current node. The first value may be 1, and the second value may be 0. Alternatively, the first value may be 0, and the second value may be 1. When the first flag is not contained in the bitstream obtained by the decoder, the value of the first flag may be the first value by default, or the value of the first flag may be the second value by default.

Exemplarily, when the first flag is activated or enabled, it indicates splitting of the current node, and when the first flag is deactivated or disabled, it indicates non-splitting of the current node. When the first flag is not contained in the bitstream obtained by the decoder, the first flag may be activated or enabled by default, or the first flag may be deactivated or disabled by default.

Exemplarily, the first flag may be a node-level flag (also referred to as “block-level flag”). For example, the first flag indicates whether the current node is allowed to be split. The decoder may determine the first flag by decoding information of the current node in the bitstream. In other words, the first flag may be carried in the information of the current node in the bitstream.

Certainly, in other alternative embodiments, the first flag may be a sequence-level flag, a picture-level flag, or a slice-level flag, and the decoder may split a picture into slices. In other words, the decoder may determine whether to split the current node based on at least one of a sequence-level flag, a picture-level flag, a slice-level flag, or a node-level flag, which is not specifically limited in the present disclosure.

In some embodiments, the first flag is determined by decoding the bitstream in the case where the size of the current node exceeds a miniPUsize.

Exemplarily, the first flag is determined by decoding the bitstream in the case where the size of the current node exceeds the miniPUsize. In the case where the first flag indicates splitting of the current node, it is determined to split the current node; otherwise, it is determined not to split the current node.

Exemplarily, the decoder may determine the miniPUsize by decoding the bitstream.

Exemplarily, the decoder may determine an LPUsize and the split depth of the LPUsize by decoding the bitstream, and then determine the miniPUsize based on the LPUsize and the split depth of the LPUsize.

In some embodiments, the S210 may include the following. The current node is determined not to be split in the case where the size of the current node is smaller than or equal to the miniPUsize.

Exemplarily, in the case where the size of the current node is smaller than or equal to the miniPUsize, the decoder may directly determine not to split the current node, rather than determining whether to split the current node based on the first flag determined by decoding the bitstream, which can improve the decoding efficiency and the decoding performance.

In some embodiments, the S220 may include the following. A second flag is determined by decoding the bitstream. The motion parameter of the current node is determined by decoding the bitstream in the case where the second flag indicates that the motion parameter of the current node is not a preset parameter.

Exemplarily, the decoder determines the second flag by decoding the bitstream. In the case where the second flag indicates that the motion parameter of the current node is not the preset parameter, the decoder determines the motion parameter of the current node by decoding the bitstream; otherwise, the decoder determines the motion parameter of the current node in another manner.

Exemplarily, the preset parameter may be any value. For example, the preset parameter may be 0 or any positive integer.

Exemplarily, the preset parameter may include a parameter(s) in at least one direction. For example, the preset parameter may include parameters in 1, 2, or 3 directions.

Exemplarily, the preset parameter may be implemented by pre-saving corresponding codes or tables in the decoder or in other manners that can indicate related information, or the preset parameter may be specified or defined in a standard protocol.

Exemplarily, when a value of the second flag is a first value, it indicates that the motion parameter of the current node is the preset parameter, and when the value of the second flag is a second value, it indicates that the motion parameter of the current node is not the preset parameter. The first value may be 1, and the second value may be 0. Alternatively, the first value may be 0, and the second value may be 1. When the second flag is not contained in the bitstream obtained by the decoder, the value of the second flag may be the first value by default, or the value of the second flag may be the second value by default.

Exemplarily, when the second flag is activated or enabled, it indicates that the motion parameter of the current node is the preset parameter, and when the second flag is deactivated or disabled, it indicates that the motion parameter of the current node is not the preset parameter. When the second flag is not contained in the bitstream obtained by the decoder, the second flag may be activated or enabled by default, or the second flag may be deactivated or disabled by default.

Exemplarily, the second flag may be a node-level flag (also referred to as “block-level flag”). For example, the second flag indicates whether the motion parameter of the current node is not the preset parameter. The decoder may determine the second flag by decoding the information of the current node in the bitstream. In other words, the second flag may be carried in the information of the current node in the bitstream.

Certainly, in other alternative embodiments, the second flag may be a sequence-level flag, a picture-level flag, or a slice-level flag, and the decoder may split a picture into slices. In other words, the decoder may determine whether the motion parameter of the current node is not the preset parameter based on at least one of a sequence-level flag, a picture-level flag, a slice-level flag, or a node-level flag, which is not specifically limited in the present disclosure.

In some embodiments, the method 200 may further include the following. The preset parameter is determined as the motion parameter of the current node in the case where the second flag indicates that the motion parameter of the current node is the preset parameter.

Exemplarily, in the case where the second flag indicates that an L1 norm of the motion parameter of the current node is the preset parameter, the preset parameter is determined as the motion parameter of the current node.

Exemplarily, the decoder determines the second flag by decoding the bitstream. In the case where the second flag indicates that the motion parameter of the current node is not the preset parameter, the decoder determines the motion parameter of the current node by decoding the bitstream; otherwise, the decoder directly determines the preset parameter as the motion parameter of the current node.

In some embodiments, the S240 may include the following. A third flag is determined by decoding the bitstream. The compensation node is determined as the prediction node for the current node in the case where the third flag indicates that a copy mode is used for the current node.

Exemplarily, the decoder determines the third flag by decoding the bitstream. In the case where the third flag indicates that the copy mode is used for the current node, the decoder determines the compensation node as the prediction node for the current node. Otherwise, the decoder determines the prediction node for the current node based on the compensation node in another manner.

In this embodiment, the decoder directly copies the compensation node as the prediction node for the current node, rather than performing a prediction process, or in other words, rather than performing a process in which the context of the current node is determined based on the compensation node and then the entropy decoder is used to output the prediction node for the current node based on the context of the current node, which can improve the decoding efficiency and the decoding performance of the decoder.

Exemplarily, when a value of the third flag is a first value, it indicates that the copy mode is used for the current node, and when the value of the third flag is a second value, it indicates that the copy mode is not used for the current node. The first value may be 1, and the second value may be 0. Alternatively, the first value may be 0, and the second value may be 1. When the third flag is not contained in the bitstream obtained by the decoder, the value of the third flag may be the first value by default, or the value of the third flag may be the second value by default.

Exemplarily, when the third flag is activated or enabled, it indicates that the copy mode is used for the current node, and when the third flag is deactivated or disabled, it indicates that the copy mode is not used for the current node. When the third flag is not contained in the bitstream obtained by the decoder, the third flag may be activated or enabled by default, or the third flag may be deactivated or disabled by default.

Exemplarily, the third flag may be a node-level flag (also referred to as “block-level flag”). For example, the third flag indicates whether the copy mode is used for the current node. The decoder may determine the third flag by decoding the information of the current node in the bitstream. In other words, the third flag may be carried in the information of the current node in the bitstream.

Certainly, in other alternative embodiments, the third flag may be a sequence-level flag, a picture-level flag, or a slice-level flag, and the decoder may split a picture into slices. In other words, the decoder may determine whether the copy mode is used for the current node based on at least one of a sequence-level flag, a picture-level flag, a slice-level flag, or a node-level flag, which is not specifically limited in the present disclosure.

In some embodiments, the method 200 may further include the following. The decoder determines the context of the current node based on the compensation node in the case where the third flag indicates that a prediction mode other than the copy mode is used for the current node. Then, the decoder determines the prediction node for the current node based on the context of the current node.

Exemplarily, the decoder determines the third flag by decoding the bitstream. In the case where the third flag indicates that the copy mode is used for the current node, the decoder determines the compensation node as the prediction node for the current node. Otherwise, the decoder determines the context of the current node based on the compensation node, and determines the prediction node for the current node based on the context of the current node.

Exemplarily, the decoder may determine inter information in the context of the current node based on the compensation node.

Exemplarily, the inter information in the context of the current node may be classified into the following categories.

(a) no inter information (No pred): when an occupancy code of the compensation node (i.e., b₀ . . . b₇) is 0, none of sub-nodes in the compensation node are populated (e.g., bP==0). In other words, when the occupancy code of the compensation node (b₀ . . . b₇) is 0, the inter information is not used for the current node (i.e., isinter=0).

(b) when sub-node i in the compensation node is empty (e.g., bPᵢ==0), sub-node i in the current node is predicted to be non-populated (i.e., Predᵢ==0).

(c) when sub-node i in the compensation node is non-empty (e.g., bPᵢ=1), sub-node i in the current node is predicted to be populated (i.e., Predᵢ=1). In this case, two cases may be further obtained according to the number of points contained in sub-node i in the compensation node. Case 1: when the number of points in sub-node i in the compensation node (e.g., denoted as NPredᵢ) exceeds threshold th, sub-node i in the current node is certainly predicted to be populated (e.g., PredLᵢ=1). Case 2: when the number of points in sub-node i in the compensation node (e.g., denoted as NPredᵢ) does not exceed the threshold th, sub-node i in the current node is not certainly predicted to be populated (e.g., PredLᵢ=0). For example, the threshold th may be 2 or another value.

It may be understood that, in the above example, the inter information determined by the decoder based on the compensation node includes Predᵢ and/or PredLᵢ, which is only an example of the present disclosure. In other alternative embodiments, the inter information may also be information in other forms or other types of information, which is not limited in the present disclosure.

In some embodiments, the method 200 may further include the following. In the case where the current node is to be split, the current node is split, and a motion parameter of a current sub-node obtained through splitting is determined until the current sub-node satisfies at least one of the following conditions: a size of the current sub-node being smaller than or equal to a miniPUsize, or a flag determined by decoding the bitstream indicating non-splitting of the current sub-node. A compensation sub-node is obtained by performing motion compensation on a reference sub-node for the current sub-node based on the motion parameter of the current sub-node. A prediction sub-node for the sub-node is determined based on the compensation sub-node.

Exemplarily, in the case where the current node is not to be split, the decoder determines the motion parameter of the current node by decoding the bitstream, the decoder determines the compensation node for the current node by performing motion compensation on the reference node for the current node based on the motion parameter of the current node, and then the decoder determines the prediction node for the current node based on the compensation node for the current node. In the case where the current node is to be split, the decoder splits the current node until the size of the current sub-node obtained through splitting is smaller than or equal to the miniPUsize or until a flag determined by decoding the bitstream indicates not to split the current sub-node, and then the decoder obtains the compensation sub-node by performing motion compensation on the reference sub-node for the current sub-node based on the motion parameter of the current sub-node, and determines the prediction sub-node for the sub-node based on the compensation sub-node.

In other words, the size of the current sub-node is smaller than or equal to the miniPUsize and the flag indicates non-splitting of the current sub-node, both of which are determination conditions for stopping further splitting of the current sub-node and trigger conditions for performing motion compensation on the current sub-node.

In some embodiments, the S210 may include the following. A first index is determined by decoding the bitstream. The current node is split based on a first split mode indicated by the first index.

Exemplarily, the first split mode may be any split mode.

For example, the first split mode may be an octree partitioning mode, a quadtree split mode, or a binary tree split mode. In the case where the decoder decodes the bitstream and the bitstream does not contain information for determining the first split mode, the first split mode can be the octree partitioning mode by default.

FIG. 10 illustrates an example of a principle of splitting a current node provided in embodiments of the present disclosure.

As illustrated in FIG. 10, when the decoder determines to split nodes at the d-th layer, the decoder can split each node with a side length of L at the d-th layer into eight sub-nodes with a side length of L/2, i.e., nodes at the (d+1)-th layer, based on the octree partitioning mode. When the decoder determines to split the nodes at the (d+1)-th layer, the decoder can split each node at the (d+1)-th layer with the side length of L/2 into eight sub-nodes with a side length of L/4, i.e., nodes at the (d+2)-th layer, based on the octree partitioning mode, and so on. The splitting of the current sub-node is stopped until the size of the current sub-node obtained through splitting is smaller than or equal to the miniPUsize or until the flag determined by decoding the bitstream indicates non-splitting of the current sub-node.

Exemplarily, the first index may be a node-level index (also referred to as “block-level index”). For example, the first index indicates that a split mode used for the current node is the first split mode. The decoder may determine the first index by decoding information of the current node in the bitstream. In other words, the first index may be carried in the information of the current node in the bitstream.

Certainly, in other alternative embodiments, the first index may be a sequence-level index, a picture-level index, or a slice-level index, and the decoder may split a picture into slices. In other words, the decoder may determine the split mode used for the current node based on at least one of a sequence-level index, a picture-level index, a slice-level index, or a node-level index, which is not specifically limited in the present disclosure.

In some embodiments, the decoder determines, by decoding the bitstream, at least one of: a flag indicating whether octree partitioning is allowed to be enabled; a flag indicating whether quadtree partitioning is allowed to be enabled; a flag indicating a partition direction when quadtree partitioning is allowed to be enabled; a flag indicating whether binary tree partitioning is allowed to be enabled; or a flag indicating a partition direction when binary tree partitioning is allowed to be enabled.

Exemplarily, the decoder can obtain the flag indicating whether octree partitioning is allowed to be enabled by decoding the bitstream.

For example, the decoder determines a flag indicating that octree partitioning is allowed to be enabled by decoding the bitstream, and obtains eight sub-nodes of the current node by performing octree partitioning on the current node based on the flag indicating that octree partitioning is allowed to be enabled. In this case, the bitstream may carry both a flag indicating that binary tree partitioning is not allowed to be enabled and/or a flag indicating that quadtree partitioning is not allowed to be enabled, or may not carry both the flag indicating that binary tree partitioning is not allowed to be enabled and/or the flag indicating that quadtree partitioning is not allowed to be enabled, which is not specifically limited in the present disclosure.

Exemplarily, when the decoder is unable to determine the flag indicating whether quadtree partitioning is allowed to be enabled or the flag indicating whether binary tree partitioning is allowed to be enabled by decoding the bitstream (e.g., the bitstream does not contain the flag indicating whether quadtree partitioning is allowed to be enabled or the flag indicating whether binary tree partitioning is allowed to be enabled), the decoder determines to use octree partitioning. In other words, when the decoder is unable to determine the flag indicating whether quadtree partitioning is allowed to be enabled or the flag indicating whether binary tree partitioning is allowed to be enabled by decoding the bitstream (e.g., the bitstream does not contain the flag indicating whether quadtree partitioning is allowed to be enabled or the flag indicating whether binary tree partitioning is allowed to be enabled), the decoder may use octree partitioning by default.

Exemplarily, the decoder determines, by decoding the bitstream, the flag indicating that quadtree partitioning is allowed to be enabled or the flag indicating the partition direction when quadtree partitioning is allowed to be enabled, and obtains four sub-nodes of the current node by performing quadtree partitioning on the current node based on the flag indicating that quadtree partitioning is allowed to be enabled and the flag indicating the partition direction when quadtree partitioning is allowed to be enabled. In this case, the bitstream may carry a flag indicating that binary tree partitioning is not allowed to be enabled, or may not carry the flag indicating that binary tree partitioning is not allowed to be enabled, which is not specifically limited in the present disclosure.

Exemplarily, the decoder determines a flag indicating that binary tree partitioning is allowed to be enabled or the flag indicating the partition direction when binary tree partitioning is allowed to be enabled by decoding the bitstream, and obtains two sub-nodes of the current node by performing binary tree partitioning on the current node based on the flag indicating that binary tree partitioning is allowed to be enabled and the flag indicating the partition direction when binary tree partitioning is allowed to be enabled. In this case, the bitstream may carry the flag indicating that quadtree partitioning is not allowed to be enabled, or may not carry the flag indicating that quadtree partitioning is not allowed to be enabled, which is not specifically limited in the present disclosure.

Exemplarily, the flag indicating whether quadtree partitioning is allowed to be enabled, the flag indicating the partition direction when quadtree partitioning is allowed to be enabled, the flag indicating whether binary tree partitioning is allowed to be enabled, or the flag indicating the partition direction when binary tree partitioning is allowed to be enabled may be a sequence-level flag or a geometric-level flag. The following may be determined by the decoder by decoding an SPS or a GBH in the bitstream, or may be carried in the SPS or the GBH in the bitstream: the flag indicating whether quadtree partitioning is allowed to be enabled, the flag indicating the partition direction when quadtree partitioning is allowed to be enabled, the flag indicating whether binary tree partitioning is allowed to be enabled, or the flag indicating the partition direction when binary tree partitioning is allowed to be enabled.

Certainly, in other alternative embodiments, the flag indicating whether quadtree partitioning is allowed to be enabled, the flag indicating the partition direction when quadtree partitioning is allowed to be enabled, the flag indicating whether binary tree partitioning is allowed to be enabled, or the flag indicating the partition direction when binary tree partitioning is allowed to be enabled may be a picture-level flag, a slice-level flag, or a node-level flag, and the decoder may split a picture into slices. In other words, the decoder may determine whether quadtree partitioning is allowed to be enabled for the current node or whether binary tree partitioning is allowed to be enabled for the current node based on at least one of a sequence-level flag, a picture-level flag, a slice-level flag, or a node-level flag, which is not specifically limited in the present disclosure.

In some embodiments, the method 200 may further include determining at least one of the following by decoding the bitstream: a flag indicating an LPUsize; a flag indicating LPU split depth; a flag indicating a miniPUsize; a flag indicating whether a motion parameter determined through decoding is allowed to be used as a preset parameter; a flag indicating whether a copy mode is allowed to be enabled; or a flag indicating whether a prediction mode other than the copy mode is allowed to be enabled.

Exemplarily, the decoder determines the flag indicating the LPUsize and the flag indicating the LPU split depth by decoding the bitstream, and then determines the miniPUsize based on the flag indicating the LPUsize and the flag indicating the LPU split depth. Alternatively, the decoder may determine the flag indicating the miniPUsize by decoding the bitstream, and then determine the miniPUsize.

Exemplarily, the decoder determines the flag indicating whether the motion parameter determined through decoding is allowed to be used as the preset parameter by decoding the bitstream. In the case where it is indicated that the motion parameter determined through decoding is allowed to be used as the preset parameter, when the decoder decodes the current node, the decoder determines the flag (i.e., the second flag mentioned above) indicating whether the motion parameter of the current node is the preset parameter by decoding the bitstream. In the case where the motion parameter of the current node is the preset parameter, the decoder directly determines the preset parameter as the motion parameter of the current node. In the case where the motion parameter of the current node is not the preset parameter, the decoder determines the motion parameter of the current node by further decoding the bitstream.

Exemplarily, the decoder determines the flag indicating whether the copy mode is allowed to be enabled by decoding the bitstream. In the case where it is indicated that the copy mode is allowed to be enabled, when the decoder decodes the current node, the decoder determines the flag (i.e., the third flag mentioned above) indicating whether the copy mode is used for the current node by decoding the bitstream. In the case where the copy mode is used for the current node, the decoder directly determines the compensation node as the prediction node for the current node. In the case where the copy mode is not used for the current node, the decoder determines the context of the current node based on the compensation node, and then the decoder determines the prediction node for the current node based on the context of the current node.

Exemplarily, the decoder determines the flag indicating whether the prediction mode other than the copy mode is allowed to be enabled by decoding the bitstream. In the case where it is indicated that the prediction mode other than the copy mode is allowed to be enabled, when the decoder decodes the current node, the decoder determines the flag (i.e., the third flag mentioned above) indicating whether the copy mode is used for the current node by decoding the bitstream. In the case where the copy mode is used for the current node, the decoder directly determines the compensation node as the prediction node for the current node. In the case where the copy mode is not used for the current node, the decoder determines the context of the current node based on the compensation node, and then the decoder determines the prediction node for the current node based on the context of the current node.

Exemplarily, the flag indicating the LPUsize, the flag indicating the LPU split depth, the flag indicating the miniPUsize, the flag indicating whether the motion parameter determined through decoding is allowed to be used as the preset parameter, the flag indicating whether the copy mode is allowed to be enabled, or the flag indicating whether the prediction mode other than the copy mode is allowed to be enabled may be a sequence-level flag or a geometric-level flag. The following may be determined by the decoder by decoding an SPS or a GBH in the bitstream, or may be carried in the SPS or the GBH in the bitstream: the flag indicating the LPUsize, the flag indicating the LPU split depth, the flag indicating the miniPUsize, the flag indicating whether the motion parameter determined through decoding is allowed to be used as the preset parameter, the flag indicating whether the copy mode is allowed to be enabled, or the flag indicating whether the prediction mode other than the copy mode is allowed to be enabled.

Certainly, in other alternative embodiments, the flag indicating the LPUsize, the flag indicating the LPU split depth, the flag indicating the miniPUsize, the flag indicating whether the motion parameter determined through decoding is allowed to be used as the preset parameter, the flag indicating whether the copy mode is allowed to be enabled, or the flag indicating whether the prediction mode other than the copy mode is allowed to be enabled may be a picture-level flag, a slice-level flag, or a node-level flag, and the decoder may split a picture into slices. In other words, for the current node, the decoder may determine the LPUsize, the LPU split depth, the miniPUsize, whether the motion parameter determined through decoding is allowed to be used as the preset parameter, whether the copy mode is allowed to be enabled, or whether the prediction mode other than the copy mode is allowed to be enabled based on at least one of a sequence-level flag, a picture-level flag, a slice-level flag, or a node-level flag, which is not specifically limited in the present disclosure.

In some embodiments, the S210 may include the following. Whether to split the current node is determined in the case where the current node satisfies a condition for enabling local motion estimation.

In other words, in the case where the current node satisfies the condition for enabling local motion estimation, the decoder determines whether to split the current node.

It is worth noting that, the condition for enabling local motion estimation may be a condition for determining whether motion compensation is allowed to be performed on the current node. The specific implementation of the condition for enabling local motion estimation is not limited in the present disclosure. In addition, the decoder may determine whether the current node satisfies the condition for enabling local motion estimation based on the decoded information. Alternatively, the decoder may determine whether the current node satisfies the condition for enabling local motion estimation by decoding the bitstream.

In some embodiments, the condition for enabling local motion estimation includes that the number of points in the reference node is greater than or equal to a preset value.

Exemplarily, in the case where the number of points in the reference node is greater than or equal to the preset value, it indicates that the current node satisfies the condition for enabling local motion estimation. In this case, the decoder determines whether to split the current node.

Exemplarily, the preset value may be any value. For example, the preset value may be 50 or any positive integer.

Exemplarily, the preset value may be implemented by pre-saving corresponding codes or tables in the decoder or in other manners that can indicate related information, or the preset value may be specified or defined in a standard protocol.

In some embodiments, the S210 may include the following. Whether to split the current node is determined in the case where the size of the current node is smaller than or equal to the LPUsize.

Exemplarily, in the case where the size of the current node is smaller than or equal to the LPUsize, the decoder determines whether to split the current node.

Exemplarily, the decoder can determine the LPUsize by decoding the bitstream.

Syntax elements involved in the present disclosure are illustrated with reference to Table 1.

In Table 1, u(n) represents an unsigned integer using n bits, and ue(v) represents an unsigned integer Exp-Golomb-coded syntax element.

TABLE 1

| | Syntax Element | | Meaning | | Descriptor |
|---|---|---|---|---|---|
| SPS | 1. | sps_PU_qt_partition_enable_flag | 1. | whether quadtree | u(1) |
| layer | | | | partitioning is allowed to | |
| | | | | be enabled for a PU | |
| | 2. | sps_PU_bt_partition_enable_flag | 2. | whether binary tree | u(1) |
| | | | | partitioning is allowed to | |
| | | | | be enabled for a PU | |
| | 3. | sps_PU_qt_partition_direction_flag | 3. | a partition direction of a | u(2) |
| | | | | PU when quadtree | |
| | | | | partitioning is allowed to | |
| | | | | be enabled | |
| | 4. | sps_PU_bt_partition_direction_flag | 4. | a partition direction of a | u(2) |
| | | | | PU when binary tree | |
| | | | | partitioning is allowed to | |
| | | | | be enabled | |
| | 5. | sps_LPU_size | 5. | LPUsize | ue(v) |
| | 6. | sps_LPU_split_depth/ | 6. | LPU split depth (may be | ue(v) |
| | | sps_miniPU_size | | replaced with miniPUsize) | |
| | 7. | sps_PU_ZeroMV_enable_flag | 7. | a flag indicating whether | u(1) |
| | | | | an MV is allowed to be | |
| | | | | encoded as 0 | |
| | 8. | sps_PU_copy_enable_flag | 8. | a direct copy mode enable | u(1) |
| | | | | flag | |
| GBH | 9. | gbh_PU_qt_partition_enable_flag | 9. | whether quadtree | u(1) |
| layer | | | | partitioning is allowed to | |
| | | | | be enabled for a PU | |
| | 10. | gbh_PU_bt_partition_enable_flag | 10. | whether binary tree | u(1) |
| | | | | partitioning is allowed to | |
| | | | | be enabled for a PU | |
| | 11. | gbh_PU_qt_partition_direction_flag | 11. | a partition direction of a | u(2) |
| | | | | PU when quadtree | |
| | | | | partitioning is allowed to | |
| | | | | be enabled | |
| | 12. | gbh_PU_bt_partition_direction_flag | 12. | a partition direction of a | u(2) |
| | | | | PU when binary tree | |
| | | | | partitioning is allowed to | |
| | | | | be enabled | |
| | 13. | gbh_LPU_size | 13. | LPUsize | ue(v) |
| | 14. | gbh_LPU_split_depth/ | 14. | LPU split depth (may be | ue(v) |
| | | gbh_miniPU_size | | replaced with miniPUsize) | |
| PU | 15. | PU_split_flag | 15. | a flag indicating whether | u(1) |
| layer | | | | to split a PU | |
| | 16. | PU_MV_Zero_flag | 16. | a flag indicating all three | u(1) |
| | | | | components of an MV are | |
| | | | | 0 | |
| | 17. | MV/MVd | 17. | three components of an | ue(v) |
| | | | | encoded MV (Mvd may be | |
| | | | | transmitted actually) | |
| | 18. | PU_copy_flag | 18. | a flag indicating whether a | u(1) |
| | | | | copy mode is used | |
| | 19. | PU_partition_idx | 19. | an index of a partitioning | u(2) |
| | | | | mode | |

As illustrated in Table 1, a corresponding relationship between the flag and the index can be as follows.

First flag: PU_split_flag.

Second flag: PU_MV_Zero_flag.

Third flag: PU_copy_flag.

First index: PU_partition_idx.

A flag indicating whether quadtree partitioning is allowed to be enabled: sps_PU_qt_partition_enable_flag or gbh_PU_qt_partition_enable_flag.

A flag indicating a partition direction when quadtree partitioning is allowed to be enabled: sps_PU_qt_partition_direction_flag or gbh_PU_qt_partition_direction_flag.

A flag indicating whether binary tree partitioning is allowed to be enabled: sps_PU_bt_partition_enable_flag or gbh_PU_bt_partition_enable_flag.

A flag indicating a partition direction when binary tree partitioning is allowed to be enabled: sps_PU_bt_partition_direction_flag or gbh_PU_bt_partition_direction_flag.

A flag indicating an LPUsize: sps_LPU_size or gbh_LPU_size.

A flag indicating LPU split depth: sps_LPU_split_depth or gbh_LPU_split_depth.

A flag indicating a miniPUsize: sps_miniPU_size or sps_miniPU_size.

A flag indicating whether a motion parameter determined through decoding is allowed to be used as a preset parameter: sps_PU_ZeroMV_enable_flag.

A flag indicating whether a copy mode is allowed to be enabled: sps_PU_copy_enable_flag.

The content provided in the present disclosure will be illustrated in combination with the syntax elements mentioned above.

### 1. Splitting of a PU

A PU is a voxel block obtained by splitting a point cloud (or slice) of a current frame according to certain rules, and the PU is the basic unit for prediction. A size of the PU may be subject to certain restrictions. For example, a PU with the maximum allowed size is referred to as an LPU, and a PU with the minimum allowed PU size is referred to as a miniPU. An LPUsize may be carried in an SPS parameter or a GBH parameter, such as sps_LPU_size and gbh_LPU_size, which can indicate the depth of the LPU in an octree partitioning structure of the current picture. A miniPUsize may be carried in the SPS parameter or the GBH parameter, such as sps_miniPU_size and gbh_miniPU_size, which can indicate the depth of the miniPU in the octree partitioning structure of the current picture or a depth difference between the miniPU and the LPU.

When point cloud coding is performed on an LPU voxel block, it is necessary to indicate how the PU (an LPU is also a PU) is split into one or more PUs. In this case, a flag PU_split_flag can be used. For example, when PU_split_flag is 1, the PU is split into multiple PUs (some nodes are empty). When PU_split_flag is 0, the PU will no longer be split. For each PU obtained through splitting, recursion is performed in the method mentioned above until one of the following two conditions is satisfied: PU_split_flag of the PU being 0, or the size of the PU being equal to the miniPUsize.

For example, PU splitting may be implemented using an octree as illustrated in FIG. 10.

Certainly, PU splitting may also be implemented using a quadtree or a binary tree, and whether the quadtree or the binary tree is allowed to be enabled can be determined by SPS parameters (e.g., sps_PU_qt_partition_enable_flag and sps_PU_bt_partition_enable_flag) and/or GBH parameters (e.g., gbh_PU_qt_partition_enable_flag and gbh_PU_bt_partition_enable_flag). In the case of using quadtree partitioning or binary tree partitioning, a partition direction needs to be further indicated.

### 2. Motion Compensation on a PU

A PU is the basic unit for temporal motion compensation.

In other words, taking a PU as a unit, the PU may have a three-dimensional MV, and a compensation node (a new geometric coordinate) is obtained by shifting a reference node according to the three-dimensional MV (a geometric coordinate+the MV). Each PU can have a syntax element PU_MV_Zero_flag. When PU_MV_Zero_flag is 0, it indicates that the MV is 0 (all components in three dimensions are 0), and MV information will no longer be coded. When PU_MV_Zero_flag is 1, it indicates that the MV is not 0, and the MV information is further to be coded. In addition, the coded three-dimensional MV may also be three-dimensional MV difference information, such as a difference from an MV of an adjacent PU. Whether the three-dimensional MV is an MV difference can be carried in an SPS parameter and/or a GBH parameter and/or a PU parameter.

### 3. A Prediction Mode for a PU

Prediction encoding is performed on geometric information of points in a PU based on a compensation node. Prediction encoding may include a copy mode and/or a prediction entropy encoding mode. Which mode is to be used is indicated by a PU-layer syntax element PU_copy_flag. For example, PU_copy_flag being 1 indicates use of the copy mode, and PU_copy_flag being 0 indicates use of the prediction entropy encoding mode.

For the copy mode, points in a node (e.g., a compensation node) corresponding to a current PU in a reference picture are directly used as points in the current PU.

For the prediction entropy encoding mode, inter information of the current PU is determined based on populated status of the points in the node (e.g., the compensation node) corresponding to the current PU in the reference picture, a context of the current PU is constructed based on the inter information of the current PU, and then prediction is performed on the points in the current PU based on the context of the current PU. For example, the context of the current PU can be used as an input, and then an entropy decoder in the decoder can be used to perform prediction on the points in the current PU.

For example, when the inter information of the current PU is determined based on the populated status of the points in the compensation node, the inter information may be classified into the following categories.

(a) no inter information (No pred): when an occupancy code of the compensation node (i.e., b₀ . . . b₇) is 0, none of sub-nodes in the compensation node are populated (e.g., bP==0). In other words, when the occupancy code of the compensation node (b₀ . . . b₇) is 0, the inter information is not used for the current PU (i.e., isinter=0).

(b) when sub-node i in the compensation node is empty (e.g., bPᵢ==0), sub-node i in the current PU is predicted to be non-populated (i.e., Predᵢ==0).

(c) when sub-node i in the compensation node is non-empty (e.g., bPᵢ=1), sub-node i in the current PU is predicted to be populated (i.e., Predᵢ=1). In this case, two cases may be further obtained according to the number of points contained in sub-node i in the compensation node. Case 1: when the number of points in sub-node i in the compensation node (e.g., denoted as NPredᵢ) exceeds threshold th, sub-node i in the current PU is certainly predicted to be populated (e.g., PredLᵢ=1). Case 2: when the number of points in sub-node i in the compensation node (e.g., denoted as NPredᵢ) does not exceed the threshold th, sub-node i in the current PU is not certainly predicted to be populated (e.g., PredLᵢ=0). For example, the threshold th may be 2 or another value.

The decoding method provided in the present disclosure is illustrated below in combination with a specific embodiment.

### Embodiment 1

Syntax elements involved in this embodiment include:
1. sps_LPU_size: the size of an LPU.
2. sps_miniPU_size: the size of an miniPU.
3. PU_split_flag: indicating whether to split a current PU.
4. MV_Zero_flag: indicating whether an L1 norm of an MV of a current PU is 0.
5. PU_copy_flag: indicating whether a copy mode is used for a current PU for prediction encoding.

Specifically, when the decoder performs PU-based inter prediction decoding according to octree partitioning, the decoder may perform the following steps.

### Step 1

All nodes at each depth (0≤depth<maxDepth) of the current picture are read from an FIFO queue, where maxDepth represents the maximum depth (the number of layers from a root node to leaf nodes) of an octree partitioning structure of the current picture.

### Step 2

For nodes at the depth-th layer, the following determination is made, where a determination condition is that the size of the current node is equal to the LPUsize and the condition for enabling local motion estimation is satisfied (e.g., the number of points in the reference node exceeds 50 or other values). If the determination condition is satisfied, the following operations are performed on the current node.

If the size of the current node is smaller than or equal to sps_miniPU_size, PU_split_flag is inferred to be 0; otherwise, a PU_split_flag is decoded. If PU_split_flag is false, motion compensation is performed on the reference node for the current node; and if PU_split_flag is true, the current node is split until the PU_split_flag of the PU is false or the size of the PU exceeds the miniPU size through iterative splitting, and then motion compensation is performed on a sub-node.

### Step 3

For a PU that requires motion compensation, MV_Zero_flag is parsed. If MV_Zero_flag is true, three components of the MV are not required to be parsed, and are directly set to 0; otherwise, three components of the MV are decoded. A compensation node for the PU can be obtained by performing motion compensation on the PU using the obtained MV.

### Step 4

A prediction mode is determined by decoding PU_copy_flag at the PU layer.

If PU_copy_flag is true, it indicates that the encoder selects the copy mode, and the decoder directly copies the compensation node to a reconstructed point cloud. In this case, subsequent decoding operations are not required. If PU_copy_flag is false, a node at a current frame needs to be decoded according to both inter information decoded from the PU and an intra context.

The decoding method provided in the present disclosure is exemplified below in conjunction with a syntax element parsing table.

Bold syntax elements represent that the syntax elements need to be parsed. For example, PU_split_flag is a syntax element at an encoding-unit level that needs to be parsed.

TABLE 2

| | |
|---|---|
| if (PU_size <= sps_LPU_size && PU_size > | |
| sps_minPU_size) { | |
| PU_{—}split_{—}flag | u(1) |
| if (PU_split_flag = = 1) { | |
| PU_{—}split( ) | u(2) |
| } | |
| else { | |
| PU_{—}MV_{—}Zero_{—}flag | u(1) |
| if (PU_MV_Zero_flag == 1) { | |
| PU_MV_x = 0;PU_MV_y = 0;PU_MV_z = 0; | |
| } | |
| else { | |
| PU_{—}MV_{—}x;PU_{—}MV_{—}y;PU_{—}MV_{—}z; | ae(v) |
| } | |
| PU_{—}copy_{—}flag | u(1) |
| if ( PU_copy_flag == 1) { | |
| PU_copy( ); | |
| } | |
| else { | |
| PU_pred_code( ); | |
| } | |
| ... | |
| } | |

As illustrated in Table 2, if PU_size<=sps_LPU_size && PU_size>sps_minPU_size is true, the decoder decodes PU_split_flag.

If PU_split_flag==1 is true, the decoder decodes PU_split( ) and performs splitting based on a split mode indicated by PU_split( ).

If PU_split_flag==1 is false, the decoder decodes PU_MV_Zero_flag. If PU_MV_Zero_flag==1 is true, the decoder determines the motion parameter as: PU_MV_x=0; PU_MV_y=0; PU_MV_z=0; and if PU_MV_Zero_flag==1 is false, the decoder decodes the motion parameter: PU_MV_x; PU_MV_y; PU_MV_z.

In addition, if PU_split_flag==1 is false, the decoder decodes PU_copy_flag and performs prediction based on a prediction mode indicated by PU_copy_flag. Specifically, if PU_copy_flag==1 is true, the decoder performs prediction by using the copy mode; and if PU_copy_flag==1 is false, the decoder performs prediction by using the prediction entropy encoding mode.

For example, for the copy mode, points in a node (e.g., a compensation node) corresponding to a current PU in a reference picture are directly used as points in the current PU. For the prediction entropy encoding mode, inter information of the current PU is determined based on populated status of the points in the node (e.g., the compensation node) corresponding to the current PU in the reference picture, a context of the current PU is constructed based on the inter information of the current PU, and then prediction is performed on the points in the current PU based on the context of the current PU. For example, the context of the current PU can be used as an input, and then an entropy decoder in the decoder can be used to perform prediction on the points in the current PU.

The preferred embodiments of the present disclosure have been described in detail above in conjunction with the accompanying drawings. However, the present disclosure is not limited to the specific details in the foregoing embodiments. Within the scope of the technical concept of the present disclosure, various simple modifications may be made to the technical solutions of the present disclosure. These simple modifications all belong to the protection scope of the present disclosure. For example, the various specific technical features described in the above specific embodiment manners can be combined in any suitable manner if there is no contradiction. As another example, any combination of various embodiments of the present disclosure can also be made, as long as they do not violate the idea of the present disclosure, which may also be regarded as the content disclosed in the present disclosure.

It may also be understood that, in various method embodiments of the present disclosure, the magnitude of a sequence number of each of the foregoing processes does not imply an execution order, and the execution order between the processes should be determined according to function and internal logic thereof, which shall not constitute any limitation to the implementation of embodiments of the present disclosure.

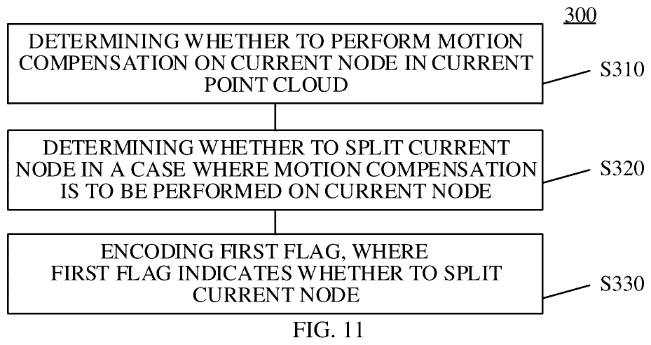

An encoding method according to embodiments of the present disclosure will be illustrated below from the perspective of an encoder in conjunction with FIG. 11.

FIG. 11 is a schematic flowchart of an encoding method 300 provided in embodiments of the present disclosure.

It may be understood that, the encoding method 300 may be performed by an encoder. For example, the encoding method 300 may be performed by the encoding device 110 or the encoder 112 as illustrated in FIG. 1. For another example, the encoding method 300 may be performed by the encoding framework 200 as illustrated in FIG. 2.

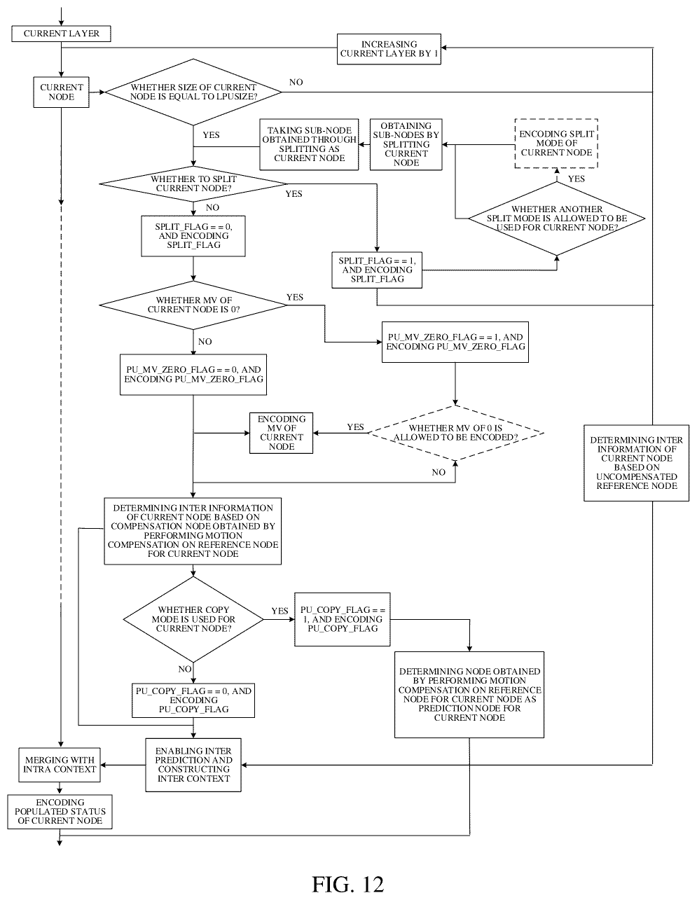

As illustrated in FIG. 12, the encoding method 300 may include the following.

At S310, whether to perform motion compensation on a current node in a current point cloud is determined.

At S320, whether to split the current node is determined in the case where motion compensation is to be performed on the current node.

At S330, a first flag is encoded, where the first flag indicates whether to split the current node.

In some embodiments, the operations at S310 may include the following. A combined mode with the lowest rate-distortion (RD) cost is determined by traversing multiple prediction modes based on a motion parameter determined in the case where the current node is not to be split and a motion parameter determined in any one of multiple split modes. Whether to split the current node is determined based on a motion parameter in the combined mode.

In some embodiments, in the case where the combined mode contains the motion parameter determined in the case where the current node is not to be split, the current node is determined not to be split.

In some embodiments, the method 300 may further include the following. A second flag is encoded, where the second flag indicates whether a motion parameter of the current node is a preset parameter.

In some embodiments, the method 300 may further include the following. The motion parameter of the current node is encoded in the case where the second flag indicates that the motion parameter of the current node is not the preset parameter.

In some embodiments, the method 300 may further include the following. A third flag is encoded, where the third flag indicates a prediction mode used for the current node.

In some embodiments, the third flag indicates that a copy mode is used for the current node, or the third flag indicates that a prediction mode other than the copy mode is used for the current node.

In some embodiments, the current node is determined to be split in the case where the combined mode contains a motion parameter in a first split mode among the multiple split modes.

In some embodiments, the method 300 may further include the following. A first index is encoded, where the first index indicates the first split mode used for the current node. In some embodiments, the method 300 may further include encoding at least one of: a flag indicating whether octree partitioning is allowed to be enabled; a flag indicating whether quadtree partitioning is allowed to be enabled; a flag indicating a partition direction when quadtree partitioning is allowed to be enabled; a flag indicating whether binary tree partitioning is allowed to be enabled; or a flag indicating a partition direction when binary tree partitioning is allowed to be enabled.

In some embodiments, the method 300 may further include encoding at least one of: a flag indicating an LPUsize; a flag indicating LPU split depth; a flag indicating a miniPUsize; a flag indicating whether a motion parameter determined through decoding is allowed to be used as a preset parameter; a flag indicating whether a copy mode is allowed to be enabled; or a flag indicating whether a prediction mode other than the copy mode is allowed to be enabled.

In some embodiments, the S310 may further include the following. Motion compensation is determined to be performed on the current node in the case where the current node satisfies a condition for enabling local motion estimation.

In some embodiments, the condition for enabling local motion estimation includes that the number of points in a reference node for the current node is greater than or equal to a preset value.

In some embodiments, the S310 may further include the following. Motion compensation is determined to be performed on the current node in the case where the size of the current node is smaller than or equal to an LPUsize.

It may be understood that, the encoding method may be understood as an inverse process of the decoding method. Therefore, for the specific solution of the encoding method 300, reference may be made to related content of the decoding method 200, which will not be repeated herein for the ease of description.

The encoding method provided in the present disclosure is illustrated below with reference to a specific embodiment.

### Embodiment 2

Syntax elements involved in this embodiment include:
1. sps_LPU_size: the size of an LPU.
2. sps_miniPU_size: the size of an miniPU.
3. PU_split_flag: indicating whether to split a current PU.
4. MV_Zero_flag: indicating whether an L1 norm of an MV of a current PU is 0.
5. PU_copy_flag: indicating whether a copy mode is used for a current PU for prediction encoding.

Specifically, when the encoder performs PU-based inter prediction encoding according to octree partitioning, the encoder may perform the following steps.

### Step 1

All nodes at each depth (0≤depth<maxDepth) of a current frame are read from an FIFO queue, where maxDepth represents the maximum depth (the number of layers from a root node to leaf nodes) of an octree partitioning structure of a point cloud of the current frame.

For nodes at the depth-th layer, the following determination is made, where a determination condition is that the size of the current node is equal to the LPUsize and the condition for enabling local motion estimation is satisfied (e.g., the number of points in the reference node exceeds 50 or other values). If the determination condition is satisfied, the following operations are performed on the current node.

### Step 2

Any PU may be split or may not be split, and a matching position of the PU in a reference picture and a corresponding MV of the PU can be determined by performing motion estimation on the PU. A split mode is selected by searching for an optimal MV under different split modes. The PU may be a PU in a current layer or a sub-PU after iterative splitting of the PU in the current layer.

### Step 3

For inter prediction performed on the PU, prediction is performed on the PU by trying various prediction modes, such as a copy mode and a prediction entropy encoding mode, according to the best matched MV.

### Step 4

An optimal PU split mode, an optimal MV, and an optimal prediction encoding mode are selected by using the RDO technology. The optimization is aimed at minimizing encoding distortion while maintaining an appropriate bitrate. For the PU, a combination of a different split mode, a different MV, and a different prediction encoding mode is tried, and distortion and bitrate that are caused by the combination are calculated. Then, the best-performing combination, i.e., the best-performing split mode, the best-performing MV, and the best-performing prediction encoding mode, is selected by comparing distortion-bitrate tradeoffs of different combinations.

### Step 5

Finally, the encoder performs optimal PU splitting based on the selected PU split mode, performs motion compensation based on the selected MV, and performs prediction encoding based on the selected prediction encoding mode.

FIG. 12 is another schematic flowchart illustrating an encoding method provided in embodiments of the present disclosure.

As illustrated in FIG. 12, the encoding method may include the following.

(a) when a size of a current node in a current layer exceeds an LPUsize, no MV can be used to perform motion compensation on a reference node for a current node, and thus an encoder can determine inter information of the current node based on an uncompensated reference node.

(b) when the size of the current node in the current layer is equal to the LPUsize, whether to split the current node is first determined.

If the current node is to be split, split_flag=1, and split_flag is encoded. In this case, the encoder can determine the inter information of the current node based on the uncompensated reference node.

In addition, the encoder obtains sub-nodes by splitting the current node, and performs subsequent operations by taking the sub-node obtained through splitting as the current node. Optionally, the encoder can further determine whether another split mode is allowed to be used for the current node. If allowed, a split mode of the current node is encoded.

If the current node is not to be split, split_flag==0, split_flag is encoded, and then whether an MV of the current node is 0 is determined. If the MV of the current node is 0, PU_MV_Zero_flag==1, and PU_MV_Zero_flag is encoded; and if the MV of the current node is not 0, PU_MV_Zero_flag==0, and PU_MV_Zero_flag is encoded. Optionally, if the MV of the current node is 0, the encoder can further determine whether the MV of 0 is allowed to be encoded. If the MV of 0 is allowed to be encoded, the MV of the current node is encoded; otherwise, the MV of the current node is not encoded.

Regardless of whether the MV of the current node is 0, the encoder determines the inter information of the current node based on the compensation node obtained by performing motion compensation on the reference node for the current node.

After the encoder determines the inter information of the current node, the encoder can enable inter prediction and construct an inter context based on the inter information of the current node, merge the inter context with the intra context, and encode populated status of the current node based on the merged context.

In addition, the encoder can further determine whether a copy mode is currently used. If the copy mode is used, PU_copy_flag==1, and PU_copy_flag is encoded. In this case, the encoder can determine the node obtained by performing motion compensation on the reference node for the current node as a prediction node for the current node; otherwise, the encoder sets PU_copy_flag==0 and encodes PU_copy_flag, enables inter prediction and constructs the inter context, merges the inter context with the intra context, and then encodes the populated status of the current node based on the merged context.

It is worth noting that, in embodiments of the present disclosure, the related information encoded by the encoder is the information that needs to be decoded by the decoder. Therefore, embodiments of the present disclosure further provide a decoding method corresponding to the encoding method in embodiments of the present disclosure, which is not repeated herein for simplicity.

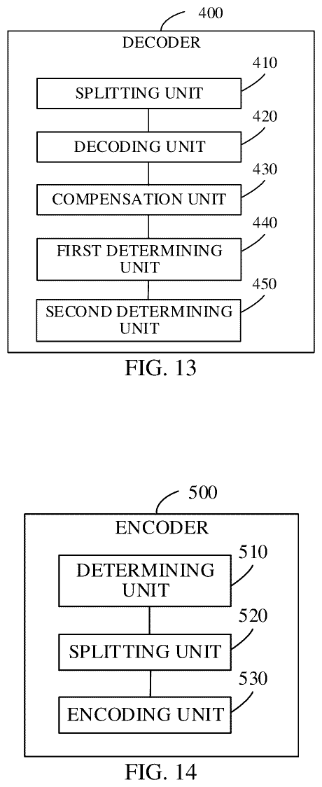

The method embodiments of the present disclosure are described in detail above, and the apparatus embodiments of the present disclosure will be described in detail below with reference to FIG. 13 to FIG. 15.

FIG. 13 is a schematic block diagram of a decoder 400 provided in embodiments of the present disclosure.

As illustrated in FIG. 13, the decoder 400 may include a splitting unit 410, a decoding unit 420, a compensation unit 430, a first determining unit 440, and a second determining unit 450. The splitting unit 410 is configured to determine whether to split a current node in a current point cloud. The decoding unit 420 is configured to determine a motion parameter of the current node by decoding a bitstream in the case where the current node is not to be split. The compensation unit 430 is configured to determine a compensation node for the current node by performing motion compensation on a reference node for the current node based on the motion parameter of the current node. The first determining unit 440 is configured to determine a prediction node for the current node based on the compensation node for the current node. The second determining unit 450 is configured to determine geometric position information of the current point cloud based on the prediction node for the current node.

In some embodiments, the splitting unit 410 is specifically configured to determine a first flag by decoding the bitstream, where the first flag indicates whether to split the current node.

In some embodiments, the splitting unit 410 is specifically configured to determine the first flag by decoding the bitstream in the case where a size of the current node exceeds a miniPUsize.

In some embodiments, the splitting unit 410 is specifically configured to determine not to split the current node in the case where the size of the current node is smaller than or equal to the miniPUsize.

In some embodiments, the decoding unit 420 is specifically configured to determine a second flag by decoding the bitstream, and determine the motion parameter of the current node by decoding the bitstream in the case where the second flag indicates that the motion parameter of the current node is not a preset parameter.

In some embodiments, the decoding unit 420 is further configured to determine the preset parameter as the motion parameter of the current node in the case where the second flag indicates that the motion parameter of the current node is the preset parameter.

In some embodiments, the first determining unit 440 is specifically configured to determine a third flag by decoding the bitstream, and determine the compensation node as the prediction node for the current node in the case where the third flag indicates that a copy mode is used for the current node.

In some embodiments, the first determining unit 440 is further configured to determine a context of the current node based on the compensation node in the case where the third flag indicates that a prediction mode other than the copy mode is used for the current node, and determine the prediction node for the current node based on the context of the current node.

In some embodiments, the splitting unit 410 is further configured to, in the case where the current node is to be split, split the current node, and determine a motion parameter of a current sub-node obtained through splitting until the current sub-node satisfies at least one of the following conditions: a size of the current sub-node being less than or equal to a miniPUsize, or a flag determined by decoding the bitstream indicating non-splitting of the current sub-node. The splitting unit 410 is further configured to obtain a compensation sub-node by performing motion compensation on a reference sub-node for the current sub-node based on the motion parameter of the current sub-node. The splitting unit 410 is further configured to determine a prediction sub-node for the sub-node based on the compensation sub-node.

In some embodiments, the splitting unit 410 is specifically configured to determine a first index by decoding the bitstream, and split the current node based on a first split mode indicated by the first index.

In some embodiments, the splitting unit 410 is specifically configured to determine, by decoding the bitstream, at least one of: a flag indicating whether octree partitioning is allowed to be enabled; a flag indicating whether quadtree partitioning is allowed to be enabled; a flag indicating a partition direction when quadtree partitioning is allowed to be enabled; a flag indicating whether binary tree partitioning is allowed to be enabled; or a flag indicating a partition direction when binary tree partitioning is allowed to be enabled.

In some embodiments, the splitting unit 410 is further configured to determine, by decoding the bitstream, at least one of: a flag indicating an LPUsize; a flag indicating LPU split depth; a flag indicating a miniPUsize; a flag indicating whether a motion parameter determined through decoding is allowed to be used as a preset parameter; a flag indicating whether a copy mode is allowed to be enabled; or a flag indicating whether a prediction mode other than the copy mode is allowed to be enabled.

In some embodiments, the splitting unit 410 is specifically configured to determine whether to split the current node in the case where the current node satisfies a condition for enabling local motion estimation.

In some embodiments, the condition for enabling local motion estimation includes that the number of points in the reference node is greater than or equal to a preset value.

In some embodiments, the splitting unit 410 is specifically configured to determine whether to split the current node in the case where a size of the current node is smaller than or equal to an LPUsize.

It may be understood that, apparatus embodiments of the decoder and method embodiments of the decoding method may correspond to each other. For similar elaborations, reference may be made to the method embodiments, which will not be repeated herein for the sake of simplicity. Specifically, the decoder 400 illustrated in FIG. 13 may correspond to a corresponding entity for implementing the decoding method 200 in embodiments of the present disclosure, and the above and other operations and/or functions of various units of the decoder 400 are respectively intended for implementing corresponding operations in the decoding method 200.

FIG. 14 is a schematic block diagram of an encoder 500 provided in embodiments of the present disclosure.

As illustrated in FIG. 14, the encoder 500 may include a determining unit 510, a splitting unit 520, and an encoding unit 530. The determining unit 510 is configured to determine whether to perform motion compensation on a current node in a current point cloud. The splitting unit 520 is configured to determine whether to split the current node in the case where motion compensation is to be performed on the current node. The encoding unit 530 is configured to encode a first flag, where the first flag indicates whether to split the current node.

In some embodiments, the splitting unit 520 is specifically configured to determine a combined mode with a lowest RD cost by traversing multiple prediction modes based on a motion parameter determined in the case where the current node is not to be split and a motion parameter determined in any one of multiple split modes. The splitting unit 520 is specifically configured to determine whether to split the current node based on a motion parameter in the combined mode.

In some embodiments, the splitting unit 520 is specifically configured to determine not to split the current node in the case where the combined mode contains the motion parameter determined in the case where the current node is not to be split.

In some embodiments, the encoding unit 530 is further configured to encode a second flag, where the second flag indicates whether a motion parameter of the current node is a preset parameter.

In some embodiments, the encoding unit 530 is further configured to encode the motion parameter of the current node in the case where the second flag indicates that the motion parameter of the current node is not the preset parameter.

In some embodiments, the encoding unit 530 is further configured to encode a third flag, where the third flag indicates a prediction mode used for the current node.

In some embodiments, the third flag indicates that a copy mode is used for the current node, or the third flag indicates that a prediction mode other than the copy mode is used for the current node.

In some embodiments, the splitting unit 520 is specifically configured to determine to split the current node in the case where the combined mode contains a motion parameter in a first split mode among the multiple split modes.

In some embodiments, the encoding unit 530 is specifically configured to encode a first index, where the first index indicates the first split mode used for the current node.

In some embodiments, the splitting unit 520 is specifically configured to encode at least one of: a flag indicating whether octree partitioning is allowed to be enabled; a flag indicating whether quadtree partitioning is allowed to be enabled; a flag indicating a partition direction when quadtree partitioning is allowed to be enabled; a flag indicating whether binary tree partitioning is allowed to be enabled; or a flag indicating a partition direction when binary tree partitioning is allowed to be enabled.

In some embodiments, the encoding unit 530 is further configured to encode at least one of: a flag indicating an LPUsize; a flag indicating LPU split depth; a flag indicating a miniPUsize; a flag indicating whether a motion parameter determined through decoding is allowed to be used as a preset parameter; a flag indicating whether a copy mode is allowed to be enabled; or a flag indicating whether a prediction mode other than the copy mode is allowed to be enabled.

In some embodiments, the determining unit 510 is specifically configured to determine to perform motion compensation on the current node in the case where the current node satisfies a condition for enabling local motion estimation.

In some embodiments, the condition for enabling local motion estimation includes that the number of points in a reference node for the current node is greater than or equal to a preset value.

In some embodiments, the determining unit 510 is specifically configured to determine to perform motion compensation on the current node in the case where a size of the current node is smaller than or equal to an LPUsize.

It may be understood that, apparatus embodiments of the encoder and method embodiments of the encoding method may correspond to each other. For similar elaborations, reference may be made to the method embodiments, which will not be repeated herein for the sake of simplicity. Specifically, the encoder 500 illustrated in FIG. 14 may correspond to a corresponding entity for implementing the encoding method 300 in embodiments of the present disclosure, and the above and other operations and/or functions of various units of the encoder 500 are respectively intended for implementing corresponding operations in the encoding method 300.

It may also be understood that, the units in the decoder 400 or the encoder 500 involved in embodiments of the present disclosure are classified based on logical functions. During practical application, the functions of one unit may be implemented by multiple units, the functions of multiple units may be implemented by one unit, or even the functions may be cooperatively implemented by one or more other units. For example, the units in the decoder 400 or the encoder 500 may be separately or wholly combined into one or more other units. For another example, or one (or more) of the units in the decoder 400 or the encoder 500 may further be divided into multiple functionally smaller units. In this way, same operations can be implemented, and implementation of the technical effects of embodiments of the present disclosure is not affected. For another example, the decoder 400 or the encoder 500 may further include another unit. During practical application, the functions may also be cooperatively implemented by another unit and may be cooperatively implemented by multiple units.

According to another embodiment of the present disclosure, a computer program (including program code) that can perform the operations of the corresponding methods may be run on a general-purpose computing device, such as a general-purpose computer, which includes processing elements and storage elements such as a central processing unit (CPU), a random access memory (RAM), and a read-only memory (ROM), to construct the decoder 400 or the encoder 500 in embodiments of the present disclosure, so as to implement the encoding method or the decoding method in embodiments of the present disclosure. The computer program may be recorded in, for example, a computer-readable storage medium, and may be loaded into an electronic device via the computer-readable storage medium and run in the electronic device, to implement the corresponding methods in embodiments of the present disclosure. In other words, the units mentioned above may be implemented by the form of hardware, or may be implemented by an instruction in the form of software, or may be implemented by a combination of hardware and software module. Specifically, each step of the method embodiments in embodiments of the present disclosure may be completed by an integrated logic circuit of hardware in a processor and/or an instruction in the form of software. The steps of the method disclosed in embodiments of the present disclosure may be directly implemented by a hardware decoding processor, or may be performed by hardware and software modules in the decoding processor. Optionally, the software module can be located in a storage medium such as an RAM, a flash memory, an ROM, a programmable ROM (PROM), or an electrically erasable programmable memory, registers, etc. The storage medium is located in a memory. The processor reads the information stored in the memory, and completes the steps of the foregoing method embodiments with the hardware of the processor.

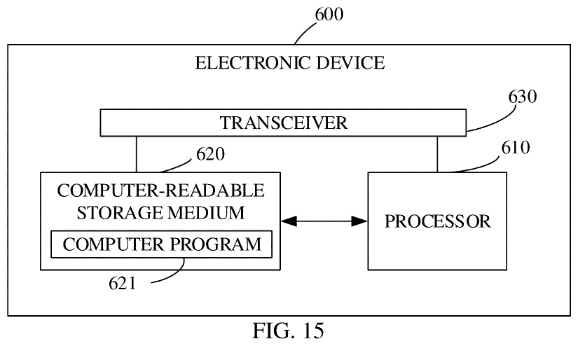

FIG. 15 is a schematic structural diagram of an electronic device 800 provided in embodiments of the present disclosure.

As illustrated in FIG. 15, the electronic device 600 at least includes a processor 610 and a computer-readable storage medium 620. The processor 610 and the computer-readable storage medium 620 may be connected via a bus or other means. The computer-readable storage medium 620 is configured to store a computer program 621, and the computer program 621 includes computer instructions. The processor 610 is configured to execute the computer instructions stored in the computer-readable storage medium 620. The processor 610 is a computing core and a control core of the electronic device 600. The processor 610 is suitable for implementing one or more computer instructions, and is specifically suitable for loading and executing one or more computer instructions to implement the corresponding method flow or corresponding function.

For example, the processor 610 may also be referred to as a CPU. The processor 610 may include, but is not limited to, a general-purpose processor, a digital signal processor (DSP), an application-specific integrated circuit (ASIC), a field programmable gate array (FPGA), or other programmable logic devices, transistor logic devices, discrete hardware components etc.

Exemplarily, the computer-readable storage medium 620 may be a high-speed RAM memory or a non-volatile memory, such as at least one magnetic disk memory. Optionally, the computer-readable storage medium 620 may be at least one computer-readable storage medium far away from the processor 610. Specifically, the computer-readable storage medium 620 includes, but is not limited to, a volatile memory or a non-volatile memory. The non-volatile memory may be an ROM, a programmable ROM (PROM), an erasable PROM (EPROM), an electrically EPROM (EEPROM), or a flash memory. The volatile memory may be an RAM that acts as an external cache. By way of example but not limitation, many forms of RAM are available, such as a static RAM (SRAM), a dynamic RAM (DRAM), a synchronous DRAM (SDRAM), a double data rate SDRAM (DDR SDRAM), an enhanced SDRAM (ESDRAM), a synclink DRAM (SLDRAM), and a direct rambus RAM (DR RAM).

Exemplarily, the electronic device 600 may be the decoder or the decoding framework provided in embodiments of the present disclosure. The computer-readable storage medium 620 is configured to store a first computer instruction. The processor 610 is configured to load and execute the first computer instruction stored in the computer-readable storage medium 620, to implement the corresponding operations of the decoding method provided in the present disclosure. In other words, the first computer instruction stored in the computer-readable storage medium 620 is loaded by the processor 610, and the corresponding operations are executed by the processor 610, which will not be repeated herein to avoid repetition.

Exemplarily, the electronic device 600 may be the encoder or the encoding framework provided in embodiments of the present disclosure. The computer-readable storage medium 620 is configured to store a second computer instruction. The processor 610 is configured to load and execute the second computer instruction stored in the computer-readable storage medium 620, to implement the corresponding operations of the encoding method provided in the present disclosure. In other words, the second computer instruction stored in the computer-readable storage medium 620 is loaded by the processor 610, and the corresponding operations are executed by the processor 610, which will not be repeated herein to avoid repetition.

According to another aspect of the present disclosure, a coding system is further provided in the present disclosure. The coding system includes the encoder and the decoder mentioned above.

According to another aspect of the present disclosure, a computer-readable storage medium (memory) is further provided. The computer-readable storage medium is a memory device in the decoder or the encoder, and is configured to store programs and data. It may be understood that, the computer-readable storage medium herein may include both a built-in storage medium in an electronic device and an extended storage medium supported by the electronic device. The computer-readable storage medium provides storage space for storing an operating system of the electronic device. In addition, the storage space further stores one or more computer instructions configured to be loaded and executed by a processor. The computer instructions may be one or more computer programs (including program codes).

According to another aspect of the present disclosure, a computer program product or a computer program is further provided. The computer program product or the computer program includes computer instructions stored in a computer-readable storage medium. A processor of a computer device reads the computer instructions from the computer-readable storage medium and executes the computer instructions, to cause the computer to perform the encoding method or the decoding method provided in the various optional embodiments described above.

In other words, when implemented by software, all or some of the above embodiments can be implemented in the form of a computer program product. The computer program product includes one or more computer instructions. When the computer instructions are loaded and executed on a computer, all or some of the operations or functions of embodiments of the present disclosure are performed. The computer may be a general-purpose computer, a special-purpose computer, a computer network, or other programmable apparatuses. The computer instructions may be stored in a computer-readable storage medium, or transmitted between one computer-readable storage medium and another computer-readable storage medium. For example, the computer instructions may be transmitted from one website, computer, server, or data center to another website, computer, server, or data center in a wired manner or in a wireless manner. Examples of the wired manner may be a coaxial cable, an optical fiber, a digital subscriber line (DSL), etc. The wireless manner may be, for example, infrared, wireless, microwave, etc.

According to another aspect of the present disclosure, a bitstream is further provided in the present disclosure. The bitstream may be a bitstream decoded using the decoding method provided in embodiments of the present disclosure or a bitstream generated using the encoding method provided in embodiments of the present disclosure.

Those of ordinary skill in the art will appreciate that units and algorithmic operations of various examples described in connection with embodiments of the present disclosure can be implemented by electronic hardware or by a combination of computer software and electronic hardware. Whether these functions are performed by means of hardware or software depends on the application and the design constraints of the associated technical solution. Those skilled in the art may use different methods with regard to each particular application to implement the described functionality, but such methods should not be regarded as lying beyond the scope of the present disclosure.

Finally, it may be noted that, the foregoing elaborations are merely embodiments of the present disclosure, but are not intended to limit the protection scope of the present disclosure. Any variation or replacement easily thought of by those skilled in the art within the technical scope disclosed in the present disclosure shall belong to the protection scope of the present disclosure. Therefore, the protection scope of the present disclosure shall be subject to the protection scope of the claims.

What is claimed is:

1. A decoding method, comprising:
determining whether to split a current node in a current point cloud;
determining a motion parameter of the current node by decoding a bitstream in a case where the current node is not to be split;
determining a compensation node for the current node by performing motion compensation on a reference node for the current node based on the motion parameter of the current node;
determining a prediction node for the current node based on the compensation node for the current node; and
determining geometric position information of the current point cloud based on the prediction node for the current node.

2. The method of claim 1, wherein determining whether to split the current node comprises:
determining a first flag by decoding the bitstream, wherein
the first flag indicates whether to split the current node.

3. The method of claim 2, wherein determining the first flag by decoding the bitstream comprises:
determining the first flag by decoding the bitstream in a case where a size of the current node exceeds a minimum prediction unit size (miniPUsize).

4. The method of claim 1, wherein determining whether to split the current node comprises:
determining not to split the current node in a case where a size of the current node is smaller than or equal to a miniPUsize.

5. The method of claim 1, wherein determining the prediction node for the current node based on the compensation node for the current node comprises:
determining a third flag by decoding the bitstream; and
determining the compensation node as the prediction node for the current node in a case where the third flag indicates that a copy mode is used for the current node.

6. The method of claim 5, further comprising:
determining a context of the current node based on the compensation node in a case where the third flag indicates that a prediction mode other than the copy mode is used for the current node.

7. The method of claim 1, further comprising:
in a case where the current node is to be split, splitting the current node, and determining a motion parameter of a current sub-node obtained through splitting until the current sub-node satisfies at least one of the following conditions: a size of the current sub-node being smaller than or equal to a miniPUsize, or a flag determined by decoding the bitstream indicating non-splitting of the current sub-node;
obtaining a compensation sub-node by performing motion compensation on a reference sub-node for the current sub-node based on the motion parameter of the current sub-node; and
determining a prediction sub-node for the sub-node based on the compensation sub-node.

8. The method of claim 1, further comprising:
determining, by decoding the bitstream, at least one of:
a flag indicating a largest prediction unit (LPU) size (LPUsize);
a flag indicating LPU split depth;
a flag indicating a miniPUsize;
a flag indicating whether a motion parameter determined through decoding is allowed to be used as a preset parameter;
a flag indicating whether a copy mode is allowed to be enabled; or
a flag indicating whether a prediction mode other than the copy mode is allowed to be enabled.

9. The method of claim 1, wherein determining whether to split the current node in the current point cloud comprises:
determining whether to split the current node in a case where a size of the current node is smaller than or equal to an LPUsize.

10. The method of claim 1, wherein determining the motion parameter of the current node by decoding the bitstream comprises:
determining a second flag by decoding the bitstream; and
determining the motion parameter of the current node by decoding the bitstream in a case where the second flag indicates that the motion parameter of the current node is not a preset parameter.

11. The method of claim 1, wherein determining whether to split the current node in the current point cloud comprises:
determining whether to split the current node in a case where the current node satisfies a condition for enabling local motion estimation.

12. An encoding method, comprising:
determining whether to perform motion compensation on a current node in a current point cloud;
determining whether to split the current node in a case where motion compensation is to be performed on the current node; and
encoding a first flag; wherein
the first flag indicates whether to split the current node.

13. The method of claim 12, wherein determining whether to split the current node comprises:
determining a combined mode with a lowest rate-distortion (RD) cost by traversing a plurality of prediction modes based on a motion parameter determined in a case where the current node is not to be split and a motion parameter determined in any one of a plurality of split modes; and
determining whether to split the current node based on a motion parameter in the combined mode.

14. The method of claim 12, further comprising:
encoding at least one of:
a flag indicating a largest prediction unit (LPU) size (LPUsize);
a flag indicating LPU split depth;
a flag indicating a miniPUsize;
a flag indicating whether a motion parameter determined through decoding is allowed to be used as a preset parameter;
a flag indicating whether a copy mode is allowed to be enabled; or
a flag indicating whether a prediction mode other than the copy mode is allowed to be enabled.

15. The method of claim 12, wherein determining whether to split the current node in the current point cloud comprises:
determining to perform motion compensation on the current node in a case where a size of the current node is smaller than or equal to an LPUsize.

16. The method of claim 12, wherein determining whether to perform motion compensation on the current node in the current point cloud comprises:
determining to perform motion compensation on the current node in a case where the current node satisfies a condition for enabling local motion estimation.

17. A non-transitory computer-readable storage medium storing thereon a computer program and a bitstream, wherein when processed by one or more processors, the computer program causes the one or more processors to implement an encoding method to generate the bitstream;
wherein the encoding method comprises:
determining whether to perform motion compensation on a current node in a current point cloud;
determining whether to split the current node in a case where motion compensation is to be performed on the current node; and
encoding a first flag; wherein
the first flag indicates whether to split the current node.

18. The non-transitory computer-readable storage medium of claim 17, wherein determining whether to split the current node comprises:
determining a combined mode with a lowest rate-distortion (RD) cost by traversing a plurality of prediction modes based on a motion parameter determined in a case where the current node is not to be split and a motion parameter determined in any one of a plurality of split modes; and
determining whether to split the current node based on a motion parameter in the combined mode.

19. The non-transitory computer-readable storage medium of claim 17, further comprising:
encoding at least one of:
a flag indicating a largest prediction unit (LPU) size (LPUsize);
a flag indicating LPU split depth;
a flag indicating a miniPUsize;
a flag indicating whether a motion parameter determined through decoding is allowed to be used as a preset parameter;
a flag indicating whether a copy mode is allowed to be enabled; or
a flag indicating whether a prediction mode other than the copy mode is allowed to be enabled.

20. The non-transitory computer-readable storage medium of claim 17, wherein determining whether to split the current node in the current point cloud comprises:
determining to perform motion compensation on the current node in a case where a size of the current node is smaller than or equal to an LPUsize.
